(19) United States
(12) Patent Application Publication
(10) Pub. No.: US 2025/0117865 A1
(43) Pub. Date: Apr. 10, 2025

(54) ENERGY AWARE APPLICATION DEPLOYMENT

(71) Applicant: INTERNATIONAL BUSINESS MACHINES CORPORATION, ARMONK, NY (US)

(72) Inventors: James McDONAGH, FRODSHAM (GB); Vasileios VASILEIADIS, DUBLIN (IE); Malgorzata Jadwiga ZIMON, WARRINGTON (GB); Gwilym Benjamin Lee NEWTON, WINCHESTER (GB); Geeth Ranmal DE MEL, WARRINGTON (GB)

(21) Appl. No.: 18/480,879

(22) Filed: Oct. 4, 2023

(51) Int. Cl. G06Q 50/06; G06Q 10/0631

(52) U.S. Cl. CPC G06Q 50/06; G06Q 10/063116; G06Q 10/06315

(57) ABSTRACT

Methods, computer program products, and systems are presented. The method computer program products, and systems can include, for instance: predicting future energy supply profiles at respective ones of a plurality of geographically differentiated computer environments, wherein the respective future energy supply profiles at the respective ones of the plurality of geographically differentiated computer environments express an attribute of supplied energy supplied to a computer environment attributable to renewable power generation; scheduling a plurality of jobs defining an application workflow, wherein the application workflow is characterized by commencement of a second job of the plurality of jobs being dependent on completion of a first job of the plurality of jobs.

### BACKGROUND

Embodiments herein relate to deployment of a software application and particularly to energy aware software application deployment.

There are a plurality of cloud based computer environment providers on the market today, each of them offering specific services with service levels, targeting specific use cases, groups of clients, vertical and geographic markets. These cloud providers compete with services of traditional IT service providers which are operated typically in on-premise environments of client owned datacenters. While cloud providers seem to have advantages over said company-owned datacenters, they are not under direct control of the client companies and there is a substantial risk of failure to provide agreed service levels. Furthermore, cloud service providers might change their service levels, prices, and service offerings more often than traditional on-premise (owned by the service consumer) information technology providers.

With the advent of cloud computing the information technology industry has been undergoing structural changes. These changes not only affect information technology companies themselves, but also the industry in general for which information technology has become an essential part of their business operations. IT departments face the need of providing infrastructure faster, driven by their lines of business, internal clients, suppliers and external customers. On the other hand, the pressure on cost effectiveness and quality of service continue to be very high. A high level of security is of utmost importance. Cloud computer environments have to fulfill similar requirements as traditional data centers in this regard, but are perceived to provide services faster and cheaper, and to have virtually endless resources available.

Location based services (LBS) are software services that use location data to control functionality of computer systems LBS information services have a number of uses, e.g., in social networking, entertainment, security, and in a plurality of additional applications. LBS services employ location services for locating mobile computer systems. Location services can incorporate a variety of different locating service technologies such as the Global Positioning System (GPS), cellular network locating technologies, and WI-FI based locating technologies, and other technologies. One example of an LBS is a location based messaging services wherein notifications and other messages to users can be in dependence on the respective locations of the users.

Data structures have been employed for improving operation of computer system. A data structure refers to an organization of data in a computer environment for improved computer system operation. Data structure types include containers, lists, stacks, queues, tables and graphs. Data structures have been employed for improved computer system operation e.g., in terms of algorithm efficiency, memory usage efficiency, maintainability, and reliability.

Artificial intelligence (AI) refers to intelligence exhibited by machines. Artificial intelligence (AI) research includes search and mathematical optimization, neural networks and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided, through the provision, in one aspect, of a method. The method can include, for example: predicting future energy supply profiles at respective ones of a plurality of geographically differentiated computer environments, wherein the respective future energy supply profiles at the respective ones of the plurality of geographically differentiated computer environments express an attribute of supplied energy supplied to a computer environment attributable to renewable power generation; scheduling a plurality of jobs defining an application workflow, wherein the application workflow is characterized by commencement of a second job of the plurality of jobs being dependent on completion of a first job of the plurality of jobs, wherein the scheduling is performed in dependence on the predicting the future energy supply profiles at the respective ones of the plurality of geographically differentiated computer environments and in dependence on a forecasting of an execution time of the first job and the second job; and deploying at least one job of the plurality of jobs defining the application workflow according to the scheduling.

In another aspect, a computer program product can be provided. The computer program product can include a computer readable storage medium readable by one or more processing circuit and storing instructions for execution by one or more processor for performing a method. The method can include, for example: predicting future energy supply profiles at respective ones of a plurality of geographically differentiated computer environments, wherein the respective future energy supply profiles at the respective ones of the plurality of geographically differentiated computer environments express an attribute of supplied energy supplied to a computer environment attributable to renewable power generation; scheduling a plurality of jobs defining an application workflow, wherein the application workflow is characterized by commencement of a second job of the plurality of jobs being dependent on completion of a first job of the plurality of jobs, wherein the scheduling is performed in dependence on the predicting the future energy supply profiles at the respective ones of the plurality of geographically differentiated computer environments and in dependence on a forecasting of an execution time of the first job and the second job; and deploying at least one job of the plurality of jobs defining the application workflow according to the scheduling.

In a further aspect, a system can be provided. The system can include, for example a memory. In addition, the system can include one or more processor in communication with the memory. Further, the system can include program instructions executable by the one or more processor via the memory to perform a method. The method can include, for example: predicting future energy supply profiles at respective ones of a plurality of geographically differentiated computer environments, wherein the respective future energy supply profiles at the respective ones of the plurality of geographically differentiated computer environments express an attribute of supplied energy supplied to a computer environment attributable to renewable power generation; scheduling a plurality of jobs defining an application workflow, wherein the application workflow is characterized by commencement of a second job of the plurality of jobs being dependent on completion of a first job of the plurality of jobs, wherein the scheduling is performed in dependence on the predicting the future energy supply profiles at the respective ones of the plurality of geographically differentiated computer environments and in dependence on a forecasting of an execution time of the first job and the second job; and deploying at least one job of the plurality of jobs defining the application workflow according to the scheduling.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1A depicts a system having an orchestrator, computer environments, user equipment (UE) devices, clients, enterprise systems, a news aggregator system, and a weather service system according to one embodiment;

FIG. 1B depicts a computer environment according to one embodiment;

FIG. 2A-2B is a flowchart illustrating a method for performance by an orchestrator interoperating with computer environments, user equipment (UE) devices, clients, enterprise systems, a news aggregator system, and a weather service system, according to one embodiment;

FIG. 3 depicts a workflow graph according to one embodiment;

FIG. 4A depicts a predictive model according to one embodiment;

FIG. 4B depicts a predictive model according to one embodiment;

FIG. 4C depicts a predictive model according to one embodiment;

FIG. 4D depicts a predictive model according to one embodiment;

FIG. 4E depicts a predictive model according to one embodiment;

FIG. 5 depicts a computing environment according to one embodiment.

### DETAILED DESCRIPTION

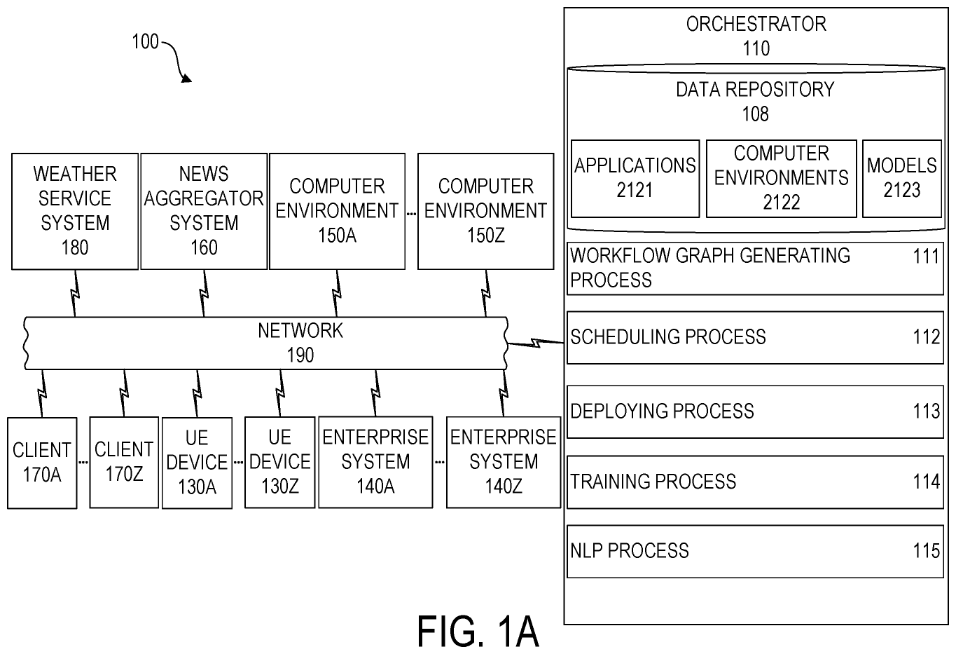

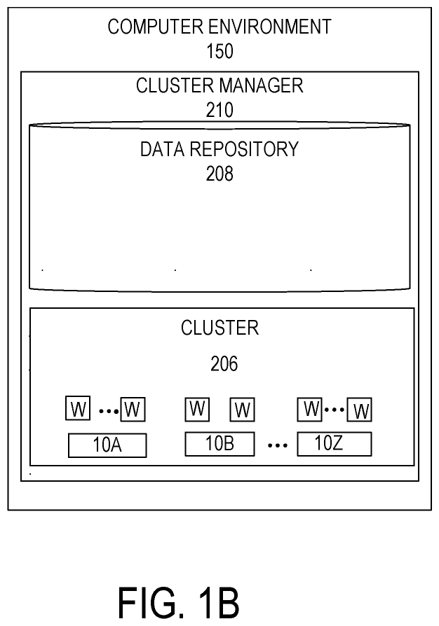

System 100 for use in performing energy aware application software deployment orchestration is shown in FIG. 1A. System 100 can include orchestrator 110, user equipment UE devices 130A-130Z, enterprise systems 140A to 140Z, computer environments 150A to 150Z, news aggregator system 160, clients 170A-170Z, news aggregator system 160 and weather service system 180. Orchestrator 110, UE devices 130A-130Z, enterprise systems 140A to 140Z, computer environments 150A to 150Z, clients 170A-170Z, news aggregator system 160 and weather service system 180 can be in communication with one another via network 190. Instances of UE devices, enterprise systems 140A to 140Z, computer environments 150A to 150Z, news aggregator system 160, clients 170A-170Z and weather service system 180 can be provided by computing node based systems each having one or more computing node.

Network 190 can be a physical network and/or a virtual network. A physical network can be, for example, a physical telecommunications network connecting numerous computing nodes or systems, such as computer servers and computer clients. A virtual network can, for example, combine numerous physical networks or parts thereof into a logical virtual network. In another example, numerous virtual networks can be defined over a single physical network. In the context of UE devices 130A-130Z, enterprise systems 140A to 140Z, computer environments 150A to 150Z, clients 170A-170Z, and computing nodes 10A-10Z, the character “Z” can refer to an integer of any arbitrary number.

In one embodiment, orchestrator 110 can be collocated with one or more of an instance of UE devices 130A-130Z, enterprise systems 140A to 140Z, computer environments 150A to 150Z, news aggregator system 160, weather service system 180 and clients 170A-170Z.

In one embodiment, orchestrator 110 can be external from each of UE devices 130A-130Z, enterprise systems 140A to 140Z, computer environments 150A to 150Z, news aggregator system 160, clients 170A-170Z and weather service system 180.

Embodiments herein can provide energy aware deployment of a software application. In one aspect, embodiments herein can employ use of a workflow graph that specifies jobs of an application and their interrelationships with other jobs of the application. In a workflow graph, respective nodes defining respective jobs of an application can have N inputs from other nodes and zero to M outputs to other nodes. The use of a workflow graph can facilitate forecasts as to timing of jobs which forecasts can facilitate optimization of renewable energy utilization. Embodiments herein can obtain metrics data from various computer environments that can host jobs defining an application. The metrics data can include metrics data that specifies an energy supply profile of a hosting computer environment.

Orchestrator 110 can perform deployment decisions in dependence on multiple factors that can include, e.g., execution time and energy utilization. Orchestrator 110 can be configured to have features to intelligently place jobs of an application workflow amongst selected ones of computer environments 150A to 150Z and can have further features so that job hosting can be dynamically changed during a deployment period of an application.

Computer environments 150A to 150Z of system 100 can be associated to respective computer environment providers. According to one embodiment, where computer environments 150A to 150Z are configured as cloud computer environments, computer environment providers associated to respective computer environments 150A to 150Z can be computer environments, e.g., data center computer environments of providers known as cloud services providers. Embodiments herein are described with reference to differentiated fictitious computer environment (cloud) providers such as ABC-CLOUD, ACME-CLOUD, MAGIC-CLOUD, and SUPERCONTAINER-CLOUD.

Computer environments 150A to 150Z can have respective application program interfaces (APIs) that allow characterizing parameters respecting the computer environments to be iteratively read by orchestrators 110. In one embodiment, a computer environment of computer environments 150A to 150Z can map to and be provided by a single data center.

In one embodiment, each computer environment 150A to 150Z can have a respective API, from which characterizing data of the respective computer environment provided by metrics data can be read and from which application performance data of live hosted applications can be read as well. Data repository 108 of orchestrator 110 can store various data. Data repository 108 in computer environments area 2122 can store computer environment characterizing data that characterizes respective computer environments 150A to 150Z. Computer environment characterizing data can include, e.g., services parameter values, scalability parameter values, cost, e.g., on a per instance basis, (SLA) parameter values, e.g., response time parameter values, throughput parameter values, CPU usage parameter values, and availability parameter values. Orchestrator 110 can be configured so that computer environment characterizing data stored in computer environments area 2122 of data repository 108 is iteratively updated to reflect changes in respective computer environments.

An embodiment of computer environment 150 representing any of computer environments 150A through 150Z is shown in FIG. 1B. Computer environment 150 can include one or more cluster manager 210 for managing one or more cluster 206 as well as one or more data repository 208 for storing various data, e.g., software images and/or metrics data. Cluster 206 can include a plurality of computing nodes 10A-10Z, which in one embodiment can be provided by physical computing nodes. Computing nodes 10A-10Z can host in one embodiment, container-based workloads, W, where each computing node of computing nodes 10A-10Z hosts of one or more container based workload W. Each workload, W, can include one or more container, i.e., a single container or more than one container. Where workload, W, includes more than one container the workload containers can be closely related containers. In another example, each workload, W, can include one or more hypervisor based virtual machine.

Enterprise systems 140A to 140Z of system 100 can be computer systems of and associated to various enterprises. Such enterprises can include, e.g., enterprises who are desirous of having their applications orchestrated for deployment by orchestrator 110 as well as other enterprises. Such other enterprises can include, e.g., regional power grid authorities that manage power grids for specific regions. In one embodiment, orchestrator 110 and/or computer environments 150A to 150Z can communicate with power grid authorities in regard to renewable energy available from a power grid and/or incentive programs in regard to renewable energy.

News aggregator system 160 can include, in one embodiment, a server with appropriate software for aggregating syndicated web content such as online new papers, blogs, podcasts in a central location for easy access. News aggregator system 160 can include a rich site summary (RSS) synchronized subscription system. RSS uses extensible markup language (XML) to structure pieces of information to be aggregated in a feed reader. Distributed updates can include, e.g., journal tables of contents, podcasts, videos, and news items. News aggregator system 160 can include human selected and entered content as well as automatically selected content, selected with use of auto-selection algorithms. Rich site summary (RSS) feeds can include text and metadata that specifies such information as publishing date and author name. In one aspect, news aggregator system 160 can be configured to archive text based reports specifying authority sponsored programs whereby an authority will offer to subsidize (pay back) a renewable energy provider to reduce power generation so as not to overload a power grid.

Weather service system 180 can be configured to provide weather data with respect to an area being serviced by system 100. Weather data can include e.g., historical temperature data, precipitation data, wind data and weather event data. Weather data can include, e.g., current temperature data, precipitation data, wind data and weather event data. Weather data can include, e.g., forecast temperature data, precipitation data, wind data and weather event data. Weather events can include, e.g., storms including hurricanes, tornados, fog formations, heat waves and cold waves. Weather service system 170 can store weather data associated to different regions (subareas) of an area being serviced by system 100.

Data repository 108 in applications area 2121 can store data on applications for orchestration by orchestrator 110. In use, orchestrator 110 can receive requests for deployment of applications from multiple enterprise systems 140A to 140Z, each associated to a different enterprise. An enterprise in making a request for deployment of an application can send to orchestrator 110 application data. The application data include, e.g., software images, e.g., container or other virtual machine images defining an application as well as service level agreement SLA requirements associated to an application for which orchestrated hosting is requested. Applications area 2121 can specify applications for which hosting orchestration has been requested. The status of such applications and, e.g., pending, running, completed etc., data associated to such applications, e.g., performance run-time metrics, identifiers for computer environments hosting jobs defining the application, workflow graphs associated to the applications and the like. In applications area 2121, there can be stored programming data such as the noted images, e.g., container or other virtual machine images, that define applications. Applications herein can refer to software applications that define information technology (IT) services.

Data repository 108 in computer environments area 2122 can store characterizing data characterizing computer environments of system 100. Orchestrator 110 in computer environments area 2122 can store, e.g., infrastructure parameter values, virtualization parameter values, infrastructure utilization parameter values, network utilization parameters values, and reliability parameter values. The described parameter values can characterize the various computer environments of computer environments 150A-150Z.

Infrastructure parameter values can include such parameter values as numbers of computing nodes provided by physical computing nodes, number of base stations serviced, numbers of clusters, numbers of computing nodes per cluster, computing node (CPU) capacity, memory capacity, storage capacity, and network capacity (bandwidth). Computing node capacity, memory capacity, and storage capacity can be expressed in terms of aggregate computer environment capacity or can be reported on a per computing node basis.

Virtualization parameter values can include, e.g., numbers of virtual machines and/or resource provisioning parameter values associated to the various virtual machines. Virtual machines herein can include, e.g., hypervisor-based virtual machines and/or container-based virtual machines.

Infrastructure utilization parameters can include, e.g., CPU utilization parameters, memory utilization parameters, and/or storage utilization parameters. It will be understood that infrastructure availability parameter values can be derived at any time with use of the reported utilization parameters based on the contemporaneously reported capacity parameter values.

Network utilization parameters can include, e.g., throughput parameter values expressed, e.g., in terms of bits per second (BPS), response time parameter values, latency parameter values, concurrent users parameter values, which specifies the number of active users at a given time, and/or a requests per second (RPS) parameter value which specifies a number of requests for a digital asset received over time. It will be understood that network availability parameter values can be derived at any time with use of the reported utilization parameters based on the contemporaneously reported capacity parameter values, including network capacity parameter values.

Reliability parameter values can include, e.g., packet loss (error rate) parameter values, mean time to failure (MTTF) parameter values, mean time to repair (MTTR) parameter values, mean time between failure (MTBR) parameter values, rate of occurrence failure (ROCOF) parameter values.

Data repository 108 in computer environments area 2122 can store data on computer environments of system 100. Computer environments of computer environments 150A to 150Z can be located in different geographical regions each having different energy supply profiles. The different energy supply profiles for example, can specify that the first computer environment can be currently powered with 50% renewable energy and 50% nonrenewable energy and a second computer environment can be currently powered with 90% renewable energy and 10% nonrenewable energy and the described ratios can vary sometimes substantially over time. In one embodiment, the different computer environments of computer environments 150A to 150Z can map to different data centers.

Data repository 108 in models area 2123 can store predictive models that have been trained by machine learning. Predictive models stored in models area 2123 can include, e.g., predictive models for predicting energy supply profiles of computer environments over time, a predictive model for predicting infrastructure utilization parameters of computer environments over time and/or a predictive model for predicting network utilization parameter values of computer environments over time, and/or a predictive model for predicting reliability parameter values over time. Orchestrator 110 can run various processes.

Orchestrator 110 running workflow graph generating process 111 can include orchestrator 110, with or without inputs of an administrator user, generating a workflow graph that specifies an application workflow. The workflow graph, in one embodiment, can be a directed acyclic graph (DAC) and can specify jobs defining an application workflow, as well as dependencies between jobs (as can be expressed with edges between nodes). Orchestrator 110 for providing candidate deployments of a multiple job application can reference a generated workflow graph. Orchestrator 110 for evaluating candidate deployments can read and write data to a generated workflow graph. A generated workflow graph as set forth herein can reference jobs as well as interconnections between jobs. The interconnections can be expressed as edges of the workflow graph. Embodiments herein recognize that various applications can be divided into discrete jobs, wherein a first job can complete, wherein a second job commencing can be dependent on a first job completing, and wherein interdependencies can be expressed between jobs. With the providing of workflow graphs, orchestrator 110 is able to separate different jobs into different time slots for execution. In using this timing information, orchestrator 110 is able to optimize energy consumption for performance of jobs, e.g., in favor of resources powered with use of renewable energy sources.

Orchestrator 110 running scheduling process 112 can include orchestrator 110 evaluating a variety of factors for identification of best hosting computer environments for hosting different jobs defining an application workflow represented in a workflow graph that expresses interrelationships and timings between jobs of an application. The multiple factors can include, e.g., an execution time factor, a reliability factor, cost factor, and an energy consumption profile factor, which can be dependent on an energy supply profile of one or more computer environment.

For performance of such evaluating, orchestrator 110 can iteratively query a plurality of computer environments for return of metrics data including such metrics data as infrastructure utilization parameter values, network utilization parameter values, reliability parameter values, and energy supply profile parameter values. Energy supply profiles parameter values returned from a computer environment can specify, e.g., a current energy supply profile for the computer environment, e.g., an energy supply profile that specifies the percentage of current energy grid power supplying power to the computer environment that is attributable to renewable power generation.

Orchestrator 110 running deploying process 113 can deploy jobs defining an application as specified in a workflow diagram according to results of the described evaluating. Orchestrator 110 in performing the deploying can deploy in some use cases different jobs defining an application on different computer environments. Orchestrator 110 running deploying process 113 can determine during running of the deployed job whether a current deployment satisfies one or more criterion. On the determination that a current deployment does not satisfy the one or more criterion, orchestrator 110 can perform rescheduling by scheduling process 112 in order to reschedule one or more jobs defining an application.

Orchestrator 110 running training process 114 can train one or more predictive model for use in returning predictions. One or more predictive model can include, e.g., a predictive model for predicting a subsequent energy supply profile of a computer environment, a predictive model for predicting a subsequent infrastructure utilization of a computer environment, or one or more predictive model for predicting a subsequent network utilization of a computer environment.

Orchestrator 110 can run NLP process 115 to process data for preparation of records that are stored in data repository 108 and for other purposes. Orchestrator 110 can run a natural language processing (NLP) process 115 for determining one or more NLP output parameter of a message. NLP process 115 can include one or more of a topic classification process that determines topics of messages and output one or more topic NLP output parameter, a sentiment analysis process which determines sentiment parameter for a message, e.g., polar sentiment NLP output parameters, “negative,” “positive,” and/or non-polar NLP output sentiment parameters, e.g., “anger,” “disgust,” “fear,” “joy,” and/or “sadness” or other classification process for output of one or more other NLP output parameters, e.g., one of more “social tendency” NLP output parameter or one or more “writing style” NLP output parameter.

By running of NLP process 115, orchestrator 110 can perform a number of processes including one or more of (a) topic classification and output of one or more topic NLP output parameter for a received message (b) sentiment classification and output of one or more sentiment NLP output parameter for a received message or (c) other NLP classifications and output of one or more other NLP output parameter for the received message.

Topic analysis for topic classification and output of NLP output parameters can include topic segmentation to identify several topics within a message. Topic analysis can apply a variety of technologies, e.g., one or more of Hidden Markov model (HMM), artificial chains, passage similarities using word co-occurrence, topic modeling, or clustering. Sentiment analysis for sentiment classification and output of one or more sentiment NLP parameter can determine the attitude of a speaker or a writer with respect to some topic or the overall contextual polarity of a document. The attitude may be the author's judgment or evaluation, affective state (the emotional state of the author when writing), or the intended emotional communication (emotional effect the author wishes to have on the reader). In one embodiment, sentiment analysis can classify the polarity of a given text as to whether an expressed opinion is positive, negative, or neutral. Advanced sentiment classification can classify beyond a polarity of a given text. Advanced sentiment classification can classify emotional states as sentiment classifications. Sentiment classifications can include the classification of “anger,” “disgust,” “fear,” “joy,” and “sadness.”

Orchestrator 110 running NLP process 115 can include orchestrator 110 returning NLP output parameters in addition to those specification topic and sentiment, e.g., can provide sentence segmentation tags, and part of speech tags. Orchestrator 110 can use sentence segmentation parameters to determine, e.g., that an action topic and an entity topic are referenced in a common sentence for example.

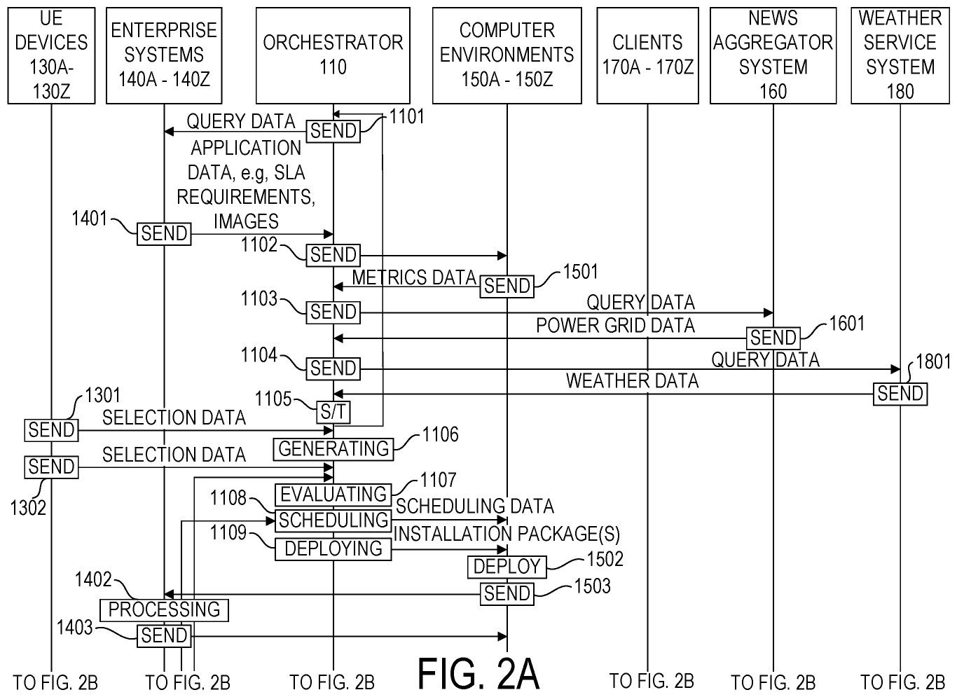

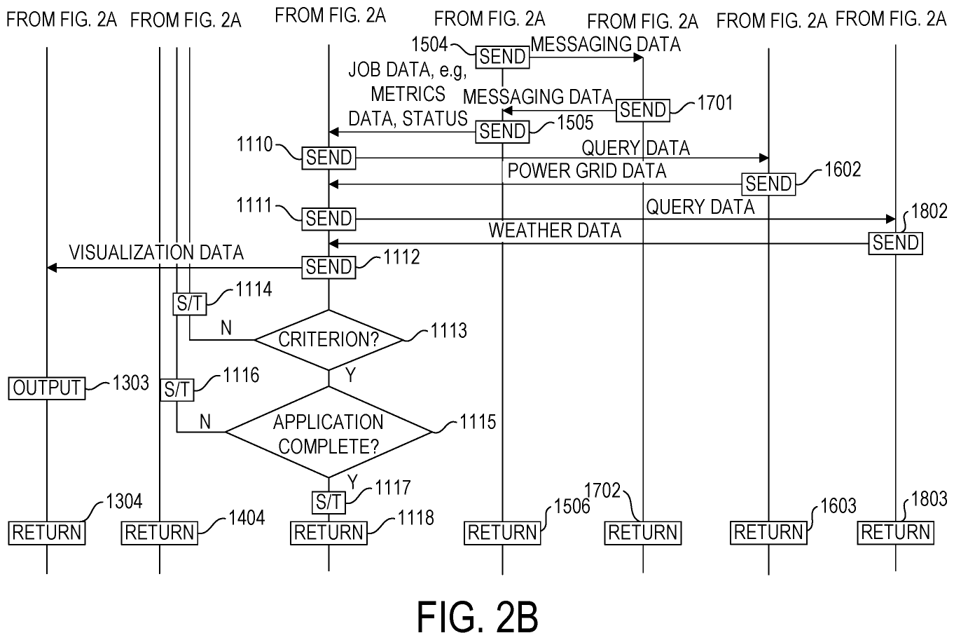

A method for performance by orchestrator 110 interoperating with enterprise systems 140A to 140Z, UE devices 130A-130Z, computer environments 150A to 150Z, clients 170A-170 Z, news aggregator system 160 and weather service system 180 as set forth in reference to the flowchart of FIGS. 2A-2B.

At block 1101, orchestrator 110 can be sending query data for querying enterprise systems 140A to 140Z. The query data sent at block 1101 can include query data for querying enterprise systems 140A to 140Z as to whether there are any new or updated application data available from the various enterprise systems 140A to 140Z. The enterprise systems 140A to 140Z can be associated to enterprises to make requests on orchestrator 110 for hosting applications developed by the various enterprises. At send block 1401, enterprise systems 140A-140Z can send application data, e.g., SLA requirements and software images, e.g., container, or other virtual machine images defining an application for which hosting is requested.

At send block 1102, orchestrator 110 can send query data to computer environments 150A to 150Z for return of metrics data from computer environments 150A to 150Z. Returned metrics data returned from computer environments 150A to 150Z at send block 1501 can include, e.g., infrastructure parameter values, infrastructure utilization parameter values, network utilization parameter values, and energy supply profiles set forth herein in reference to computer environments area 2122 of data repository 108. Query data sent at block 1102 can specify hosting parameter values, include SLA requirements of a hosting request, when known. Where more specific hosting information is sent to the computer environment, returned metrics data can be more specific, and can include, e.g., infrastructure parameter values, infrastructure utilization parameter values, network utilization parameter values, and energy supply profiles for specific offered resources. Otherwise, returned metrics data can be more generalized, and can include, e.g., infrastructure parameter values, infrastructure utilization parameter values, network utilization parameter values, and energy supply profiles for specified classifications of workloads, for example.

At send block 1103, orchestrator 110 can send query data for querying news aggregator system 160 for return of power grid data from news aggregator system 160. Embodiments herein recognize that some authorities, e.g., associated to geographical regions defined by, e.g., country, states, municipalities can sponsor programs, whereby a renewable energy provider can be compensated to disable the renewable energy sources and there is risk of a renewable energy provider overloading a power grid. Embodiments herein recognize that such scenarios where such credits are available can be indicative of a situation where a computer environment associated to an authority at a specific geographical region may be willing to offer renewable energy powered resources at a reduced rate, i.e., on receipt of power grid data sent at block 1601, orchestrator 110 can subject such power grid data to natural language processing, identifying of topic specifying situations of renewable energy credit as set forth herein.

At block 1104, orchestrator 110 can send query data for querying weather service system 180 for return of forecasted weather conditions. Embodiments herein recognize that power grid consumption can be dependent on weather patterns and thus, orchestrator 110 can use weather data such as weather data returned at block 1801 for training of predictive models that predict trends in energy supply profiles of various computer environments associated to various geographical regions.

On receipt of the weather data sent at block 1801, orchestrator 110 can proceed to store and train block (S/T) 1105. At S/T block 1105, orchestrator 110 can store the received data sent at block 1401, 1501, 1601 and 1801 into associated storage areas of data repository 108 and can perform machine learning of various models stored and can perform training of various models stored in models area 2123 of data repository 108. On completion of S/T block 1105, orchestrator 110 can proceed to generating block 1106.

At generating block 1106, orchestrator 110 can perform generating of a workflow graph that specifies an application workflow of an application subject to a hosting orchestration request. The workflow graph, in one embodiment, can be a directed acyclic graph (DAC) and can specify jobs defining an application workflow, as well as dependencies between jobs (as can be expressed with edges between nodes). Orchestrator 110 for providing candidate deployments of a multiple job application can reference a generated workflow graph. Orchestrator 110 for evaluating candidate deployments can read and write data to a generated workflow graph. A generated workflow graph as set forth herein can reference jobs as well as interconnections between jobs, expressed as edges of the workflow graph.

Embodiments herein recognize that various applications can be divided into discrete jobs, wherein a first job can complete, wherein a second job commencing can be dependent on the first job completing, and wherein interdependencies can be expressed between jobs. With the providing of workflow graphs, orchestrator 110 is able to separate different jobs into different time slots for execution. In using this timing information, orchestrator 110 is able to optimize energy consumption for performance of jobs, e.g., in favor of resources powered with use of renewable energy sources. A computational application workflow represented by a workflow graph typically contains the following information: The jobs to execute, e.g., the execution logic of such jobs and other information, e.g., a job's, executable command line, container image, code to execute, etc. Job information can alternatively or additionally can include, e.g., information on how jobs consume inputs and produce their outputs (i.e., the dependencies between jobs).

From the described job information, orchestrator 110 can produce a graph of jobs, referenced herein as a workflow graph. A workflow graph herein, in one embodiment, can be provided by a directed acyclic graph wherein nodes in the graph reference jobs and edges indicate data dependencies between jobs. Generally, a job referenced in a workflow graph is ready to execute when the node that represents it either does not have any inbound edges or all of its inbound edges represent a satisfied data dependency. In most cases, a job dependency can be regarded to be satisfied if the job which produced the data ran to completion successfully.

Generating at block 1106 can include orchestrator 110 subjecting application software code defining an application to static analysis and/or runtime analysis. Static analysis of software code defining an application can include, e.g., syntax analysis, semantic analysis, control flow analysis, fault analysis, and interface analysis, and the like. In one embodiment, software code defining an application can include software images, such as virtual machine images, e.g., container based or hypervisor based. In one embodiment, runtime instances of the described images can define respective jobs, wherein the respective jobs and their interrelationships can define an application workflow.

At generating block 1106, orchestrator 110 can subject an application to dynamic runtime analysis. For performance of a dynamic runtime analysis, an application for hosting can be temporarily run in a test environment for return of various data, e.g., system call data that is indicative of interrelationships between jobs defining an application. Dynamic runtime analysis can include, e.g., dynamic data flow analysis, dynamic symbol execution, code coverage testing, invariant errors testing, concurrency error testing, program slicing, and performance analysis, memory error detection, analysis and the like. Workflow orchestration tools can perform static analysis and/or dynamic analysis of software code defining an application, and can output based on the performance of the static analysis and/or dynamic analysis of software code text based reports, and/or workflow graph products, e.g., incomplete workflow graphs for editing and/or augmenting, or complete workflow graphs in condition for deployment.

Tools, e.g., static analysis tools, runtime analysis tools, workflow orchestration tools, to be activated at generating block 1106 can be dependent on selection data specified by developer user and sent at send block 1301 by a UE device associated to the developer user. Depending on the static/dynamic runtime tools selected, outputs can take the form of text based reports for review by the an administrator user and/or a workflow graph having nodes mapping to edges and interconnected edges.

For completion of generating a workflow graph at block 1106, a generated workflow graph can be finalized based on selection data sent at block 1302, wherein the selection data sent at block 1301 has been defined by the developer user who defined the selection data sent at block 1301.

The selection data sent at block 1302 can include selection data that, e.g., accepts, edits or augments output elements defining a workflow graph generation supporting output with use of static and/or runtime analysis tools at generating block 1106. On completion of generating at generating block 1106, orchestrator 110 can proceed to evaluating block 1107. At evaluating block 1107, orchestrator 110 can perform evaluating of candidate solutions for hosting of an application subject to workflow graph generation at generating block 1106. In some use cases, embodiments herein recognize that an administrator user, in some use cases, can have detailed understanding of all interrelationships and elements of an application's jobs. In some use cases, selection data sent at block 1302 can specify a complete workflow graph authored by a developer user used by orchestrator 110 without use of results by static and/or runtime analysis tools. In other use cases, a static and/or runtime analysis tool can completely generate a workflow graph for deployment without any editing by an administrator user. In other use cases, a static and/or runtime analysis tool can completely generate workflow graph products which are edited or augmented by the described selection defined by the developer user.

Regarding generating at block 1106, orchestrator 110 at generating block 1106 can, by way examining operation of an application in a test environment, obtain an estimate as to execution times of the various jobs expressed as nodes in a workflow graph. Orchestrator 110 can use the estimates as a baseline predictor of execution times of jobs in subsequent evaluating of candidate deployments with use of Eq. 1. Embodiments herein recognize that execution times of the various jobs mapping to nodes in an actual orchestrated multi-computer environment hosting environment can be expected to vary depending on conditions associated to the various hosting computer environments. Nevertheless, the initial estimates of execution times and corresponding predictions (forecasts) as to run times generated at generating block 1106 can be useful in performing an initial scheduling of a multi-job application prior to historical production computer environment metrics associated to the application being available.

Embodiments herein recognize that various applications can include discrete jobs that are dependent on and timewise related to various other jobs defining the application. In one example, a multi-job application can be a machine learning application, wherein the machine learning application can include a raw data collection stage in which raw data is collected. The raw data collection stage, in one example, can include digesting data resulting from communications with end-users of a service or from other data sources. In a second stage which is performed subsequent to a data collection stage being complete, collected data can be prepared for use as training data. Data preparation can include data cleaning operations such as removing inconsistencies of labels, units, format and the like. A third stage which is performed subsequent to the data preparation stage can be a machine learning training stage. In a machine learning training stage, cleaned data output by a data preparation stage can be applied to the machine learning model. In a fourth stage, which is performed subsequent to the third stage, the machine learning model can be tested, e.g., with use of holdout data testing methods, and in a fifth stage, which is performed subsequent to the fourth stage, the trained and tested machine learning model can be subject to queries for output of returned predictions.

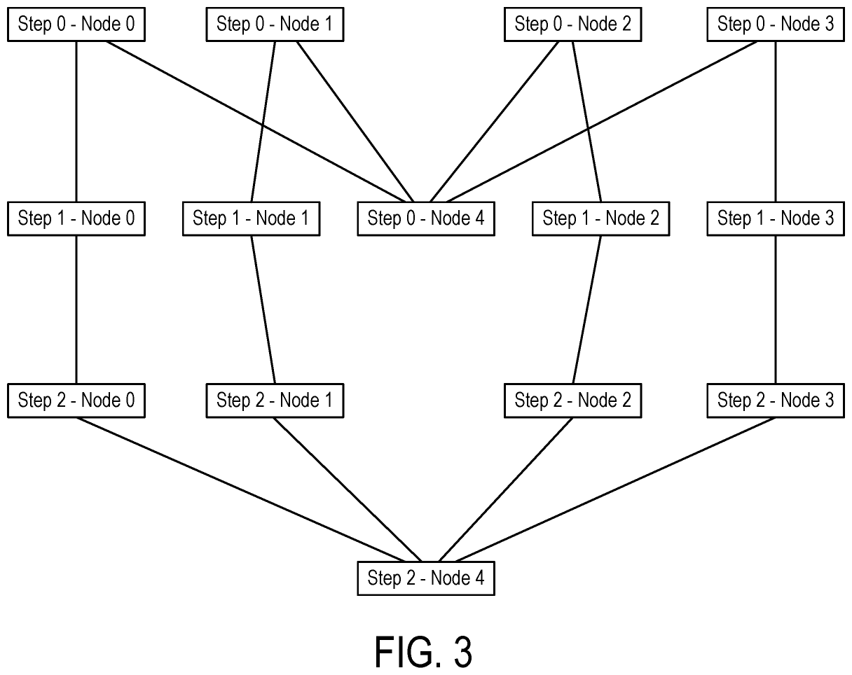

FIG. 3 illustrates an example of a workflow graph. For example, according to the workflow graph of FIG. 3, it is indicated that various functions associated to various nodes must complete before another node initiates processing. In the workflow diagram of FIG. 3, the different nodes can specify different jobs. According to the workflow diagram of FIG. 3, it is indicated that node 4 must wait for steps 0 of node 0, step 0 of node 1, step 0 of node 2, and step 0 of node 3 must complete prior to commencing further. For example, step 2 of node 2 (job 2) must wait for completion of step 1 by node 2 (job 2).

By leveraging the data structure provided by a workflow graph to organize relationships between interrelated jobs defining an application, the techniques described herein can increase efficiency in locating relevant content that can be extracted for use in intelligent deployment of an application workflow. By leveraging the data structure provided by a workflow graph to organize relationships, the techniques described herein can reduce computational resources that are expended in intelligently deploying applications.

At evaluating block 1107, orchestrator 110 can evaluate a plurality of candidate deployments. For providing candidate deployments, orchestrator 110, at evaluating block 1107, can filter out invalid deployments that are incapable of satisfying SLA requirements of an application for hosting as specified by SLA requirements data sent at block 1401. As indicated by the loop subsequent to block 1105, orchestrator 110 can return to stage preceding block 1101 and can iteratively perform the loop of blocks 1101 to 1105 during a deployment period of orchestrator 110. Simultaneously, orchestrator 110 can branch to perform generating block 1106 and subsequent blocks.

Orchestrator 110 performing evaluating at block 1107 is described further in reference to Table A illustrating various candidate deployments.

TABLE A

| Candidate | Computer | Computer | Computer |
|---|---|---|---|
| deployment | Environment A | Environment B | Environment C |
| 1 | J1, J2, J3, J4 | — | — |
| 2 | J1, J2 | J3, J4 | — |
| 3 | J3 | J2, J4 | J1 |
| . . . | . . . | . . . | . . . |

In the scenario depicted in Table A, there are jobs J1, J2, J3, J4 which can be expressed as nodes within a workflow graph, wherein according to one example, job J4 must wait for completion of job J3 to commence, wherein job J3 must wait for job J2 to commence, and wherein job J2 must wait for job J1 to commence.

According to the candidate deployments in Table A, there are computer environments A, B and C. According to candidate deployment 1, each of jobs J1 to J4 are deployed on computer environment A. According to candidate deployment 2. jobs J1 and J2 are hosted on computer environment A and jobs J3 and J4 hosted on computer environment B. In candidate deployment 3, job J1 is hosted on computer environment A, job J2 is hosted on computer environment C, job J3 is hosted on computer environment C and job J4 is hosted on computer environment B. Orchestrator 110 can provide and evaluate additional and in one embodiment all possible permutations of candidate deployments.

In reference to Table A, it can be seen that a workflow graph representing an application workflow can facilitate evaluations of candidate deployments in which changes in energy supply profiles can be intelligently considered. In the scenario depicted in Table A according to a workflow graph, job J4 can commence after completion of job J3, which can commence after completion of job J2, which can commence after completion of job J1. Thus, in determining hosting for job J4, orchestrator 110 can predict a timeslot for job J4 based on an aggregate execution time of jobs J1, J2, and J3. In a further aspect, orchestrator 110 can predict a timeslot for J4 in dependence on predicted data transmission times between jobs. In one aspect, orchestrator 110 can include in a predicted execution time for a job, the predicted data delivery time to the next job, which can be determined in dependence on a geographical separation between jobs. For example, in candidate deployment 3 of Table A, jobs J3 and J4 are separated between different computer environments, and thus a predicted execution time of job J3 can include a predicted data delivery time between the hosting computer environment of jobs J3 and J4.

Referring to Table A, embodiments herein recognize that for energy aware orchestration, different computer environments may offer optimized energy supply profiles at different times. For example, at time 1, a first computer environment A can exhibit an energy supply profile of 90% renewable and a second computer environment B can exhibit an energy supply profile of 20% renewable. However, at a subsequent time, time 2, the first computer environment A can exhibit an energy supply profile of 30% renewable and the second computer environment B can exhibit an energy supply profile of 85% renewable.

The different energy supply profiles can be dependent on a variety of factors. Embodiments herein recognize that the availability of renewable energy can be dependent on a variety of factors, e.g., weather patterns. In one example, wind weather patterns can impact expected wind renewable energy generation, and/or tidal renewable energy generation. Sunlight impacting weather patterns can impact expected solar renewable energy generations. Weather patterns can also influence air conditioning or heating use by consumers. Energy consumption can also exhibit daily, and/or seasonal trends.

For performance of evaluating of the candidate deployments, orchestrator 110 at evaluating block 1107 can apply Eq. 1 hereinbelow, wherein S is an overall scoring value for a candidate deployment.

$$S = F 1 W 1 + F 2 W 2 + F 3 W 3 + F 4 W 4 \qquad ( Eq . 1 )$$

Where S is the overall score for a candidate deployment, F1 to F4 are factors and W1 to W4 are weights associated to the various factors.

In one embodiment, F1 can be an execution time factor, F2 can be a reliability factor, F3 can be a cost factor and F4 can be an energy consumption profile factor.

Referring to factor F1, orchestrator 110 applying factor F1 can score each candidate deployment according to aggregate execution time, taking into account execution time of a collection of job (jobs J1-J4 in the described example). In scaling of scoring values under factor F1, orchestrator 110 can aggregate predicted (forecasted) execution times of multiple jobs. In predicting an execution time of a given job, orchestrator 110 can include a predicted environment running time for the job as well as a predicted time for data delivery from a first job to a second job. Where a candidate deployment includes jobs hosted on differentiated computer environments (e.g., jobs J1 and J2 of candidate deployment 3 of Table 3), orchestrator 110 can predict the data delivery time in dependence on the geographical distance between the hosting location of the first job and the hosting location of the second job.

Orchestrator 110 applying factor F2 can scale scoring values assigned under factor F2 in dependence on the aggregate reliability of the collection of jobs (jobs J1-J4 in the described example) at each computer environment according to the candidate deployment.

Orchestrator 110 applying factor F3 can scale scoring values under factor F4 according to the aggregate cost of the deployment of the collection of jobs defining an application (jobs J1-J4 in the described example) at each computer environment according to the candidate deployment. For scaling scoring values under factor F4, orchestrator 110 can ascertain an average hosting cost for unit resource per unit time for each computer environment considered for hosting based on returned metrics returned at block 1501 which can include cost metrics. Orchestrator 110 can then predict a future cost of hosting at a given computer environment at a given future time slot in dependence on a predicted availability at the given computer environment at the given future time slot, which prediction can be returned with use of querying of predictive model 4202. More specifically, orchestrator 110 can scale predicted future cost upward from a baseline where predicted availability is lower than a baseline value and scale predicted future cost downward from a baseline where predicted availability is higher than a baseline.

Orchestrator 110, applying factor F4, can scale scoring values under factor F4 according to the aggregate energy consumption profile of the collection of jobs defining an application (jobs J1-J4 in the described example) at each computer environment according to the candidate deployment. In scaling of scoring values under factor F4, orchestrator 110 can aggregate predicted (forecasted) energy consumption profile of multiple jobs. In predicting an energy consumption of a given job, orchestrator 110 can include a predicted environment energy consumption for the job as well as a predicted energy consumption of data delivery from a first job to a second job. Where a candidate deployment includes jobs hosted on differentiated computer environments (e.g., jobs J1 and J2 of candidate deployment 3 of Table 3), orchestrator 110 can predict the energy consumption profile of the first job in dependence on the geographical distance between the hosting location of the first job and the hosting location of the second job. An energy consumption profile herein can include such information, as the total energy consumption of a job, the percentage of consumed energy supplied by renewable power generation source(s), and the percentage of consumed energy supplied by nonrenewable power generation source(s). Orchestrator 110, applying factor F4, can scale scoring values under factor F4 according to one embodiment so that an assigned scoring value for a given candidate deployment is inversely dependent on a forecasted aggregate amount of consumed non-renewable energy for the deployment.

Orchestrator 110 can ascertain a predicted energy consumption of a job as a function to the forecasted execution time for the job, and the predicted resources for performance of the job. As noted herein, the predicted resources for support of a job can be predicted with improved accuracy after an initial scheduling of a multi-job application, e.g., based on processing of RET images herein.

In providing aggregate scoring values for each factor, orchestrator 110 can aggregate scoring values for the individual computer environment deployment of each job (jobs J1-J4 in the described example) defining the set of jobs of an application workflow.

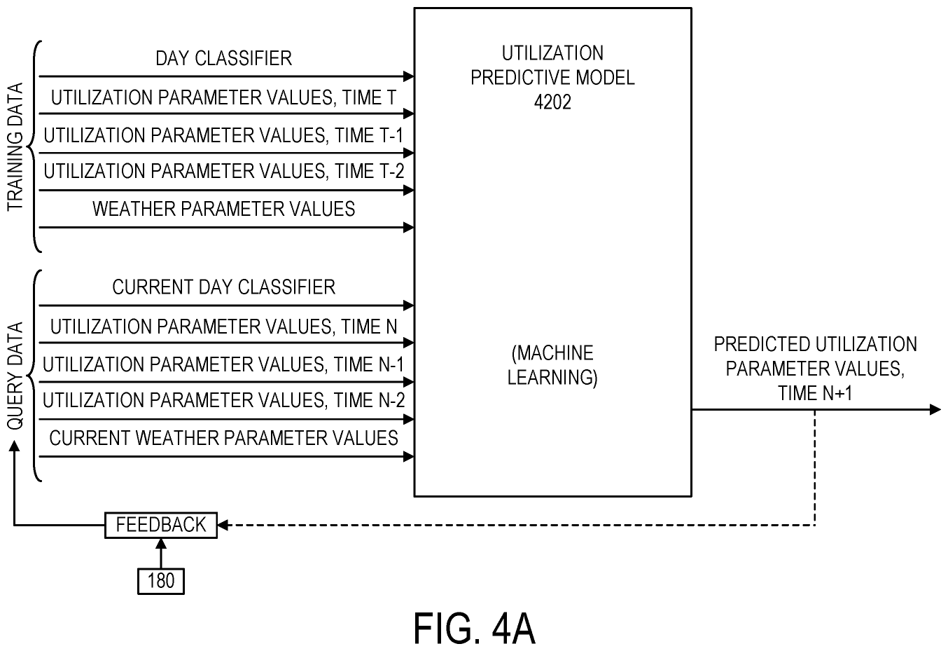

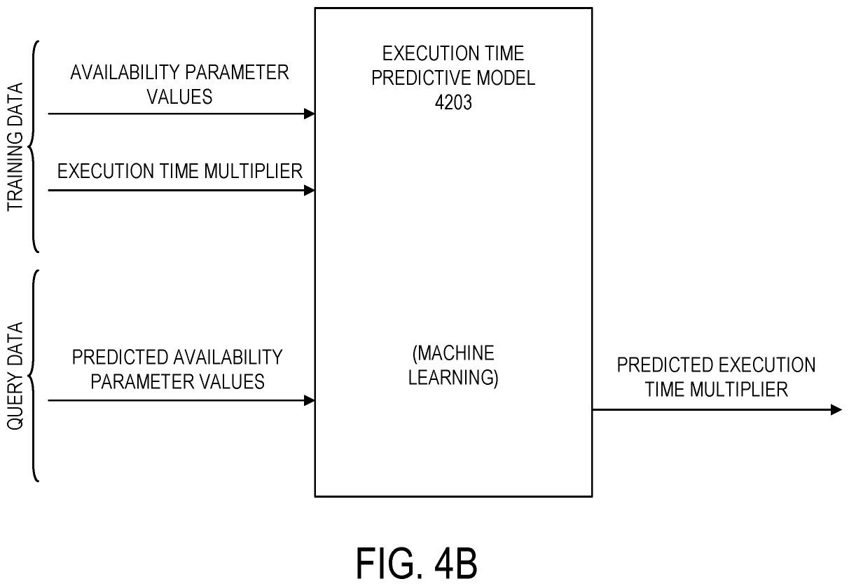

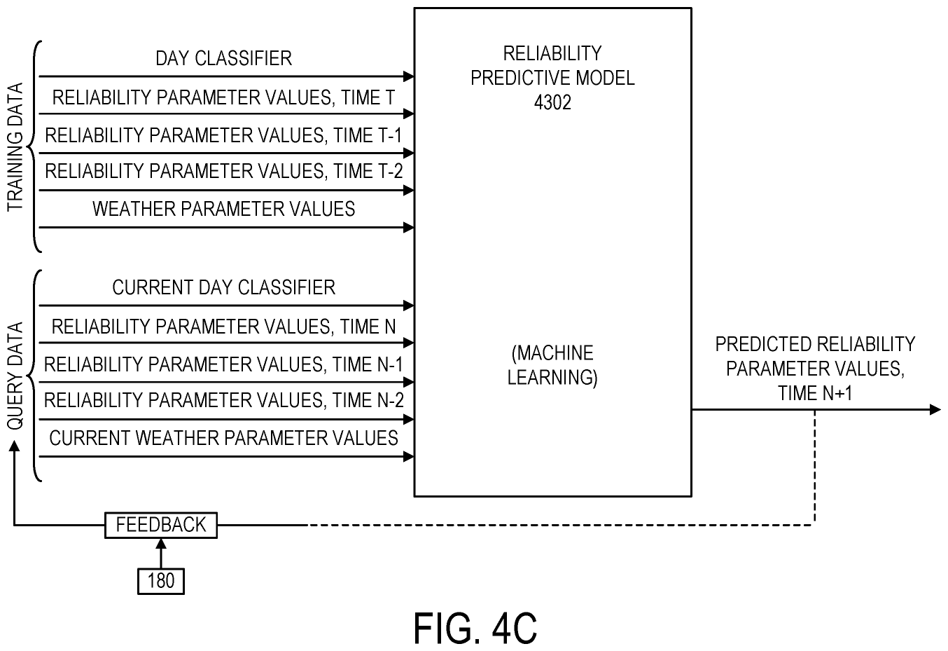

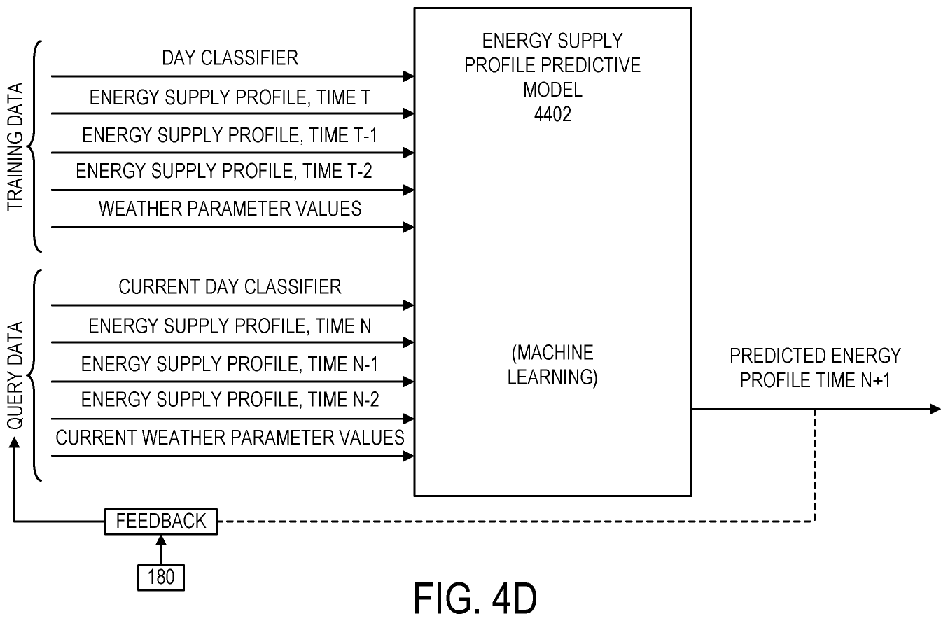

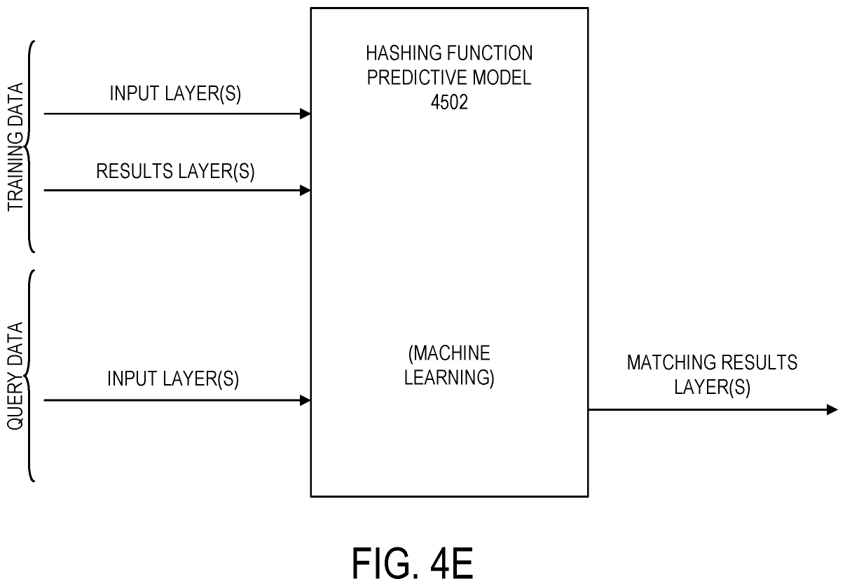

Orchestrator 110 in assigning Eq. 1 scoring values can, for factor F1 and F2, query predictive models according to predictive model 4202 as shown in FIG. 4A and predictive model 4302 as shown in FIG. 4C. FIG. 4A depicts a utilization predictive model 4202 for predicting infrastructure utilization, network utilization, in a subsequent time period relative to a current time. FIG. 4C depicts a reliability predictive model 4302 for predicting reliability in subsequent time period relative to a current time.

Utilization predictive model 4202 can be trained with training data, and once trained, can be capable of predicting computer environment utilization parameter values in a subsequent time period. Utilization predictive model 4202 can be trained with iterations of training data. An iteration of training data for training utilization predictive model 4202 can be applied each time set of utilization parameter values is collected from a given computer environment (e.g., see block 1501 and/or 1503).

Each set of training data can include a day classifier, e.g., weekday, weekend, holiday associated to the time at which the utilization parameter value data collection occurred. A set of utilization parameter values at time T, the time of data collection, a set of utilization parameter values at time T−1, i.e., the set of utilization parameter values at the time preceding the data collection time, utilization parameter values at time T−2, and additional utilization parameter values up to time T-x and weather parameter values. In one embodiment the weather parameter values can be expanded to include weather parameter values at time T−1 and T−2.

The described training data set can be applied for successive values of T associated to each new data collection period in metrics data from a particular computer environment is obtained. Trained as described, utilization predictive model 4202 is able to learn a dependency between a day classifier, utilization parameter values at successive time parameters at successive time periods and weather parameter values.

Trained as described, utilization predictive model 4202 is able to return predictions in regard to utilization parameter values of the computer environment at a subsequent time period. Query data for querying utilization predictive model 4202 can include a current day classifier, utilization parameter values for the current time N, i.e., the last data collection period for a certain computer environment, utilization parameter values for time N−1, utilization parameter values for time N−2, and a set of current weather parameter values indicating current weather conditions for a geographical area associated to a certain computer environment for which predicted utilization parameter values are being evaluated. On application of query data, utilization predictive model 4202 can return a prediction specifying predicted utilization parameter values for a certain computer environment at a subsequent time period. Orchestrator 110 can train instances of utilization predictive model 4202 for each computer environment being queried by orchestrator 110.

Orchestrator 110 can maintain instances of utilization predictive model 4202 for infrastructure utilization parameter values and network utilization parameter values. As set forth herein, availability parameter values are derivable from utilization parameter values. Orchestrator 110 can train instances of utilization predictive model 4202 for different time sensitivities. For example, a first instance of utilization predictive model 4202 can be trained for fine time sensitivity wherein the timing periods T−1 and T−2 are on the scale of minutes and a second instance of utilization predictive model 4202 and a coarser timing sensitivity, when the times T−1 and T−2 are on the scale of hours. Orchestrator 110 can query the instance with finer time sensitivity where prospective deployment of a job specified in a workflow is an earlier, e.g., first deployment and can query a coarser query in instance of utilization predictive model 4202 having a coarser time sensitivity where the job deployment being scored using Eq. 1 is a later deployment.

Orchestrator 110 can assign scoring values under factor F1 (execution time) in dependence on a result of querying one or more instance of utilization predictive model 4202 and in some embodiments one or more additional predictive model such a predictive model for return of an execution time multiplier. Embodiments herein recognize that execution speed of an arbitrary job can be dependent on availability, which is derivable from utilization. Orchestrator 110 can query instances of execution time predictive model 4203 as shown in FIG. 4B for deriving an execution time multiplier in dependence on predicted next time period availability parameter values provided by querying utilization predictive model 4202. Execution time predictive model 4203 can be trained via supervised machine learning wherein training data iterations include availability parameter value sets trained on the known execution time multiplier for the availability parameter value set of the training dataset. With an execution time multiplier known, orchestrator 110 can multiply a predicted baseline execution time for a job associated to a node as part of a candidate deployment explained with reference to Table A being evaluated.

Prior to any production environment deployment of a job, the predicted baseline execution time of a job, subject to adjustment in reference to a future timeslot using the methodologies described in reference to utilization predictive model 4202 and execution time predictive model 4203, can be obtained based on result data resulting from running of a job in a test environment as explained in reference to generating block 1106. However, after initiating production environment deployment of one or more job defining an application, orchestrator 110 can obtain a more refined predicted baseline execution time of a job. By processing of instantiations of resource extraction test (RET) image herein, a computer environment can report refined resource offering data, and orchestrator 110, e.g., via appropriate lookup of specification data of the offered resources specified in the resource offering data, can produce a more accurate prediction as to a baseline execution time for a job, which estimate can be adjusted in reference to a future timeslot with use of methods described in reference to utilization predictive model 4202 and/or execution time predictive model 4203. When sufficient historical execution time results are available production running of an application, orchestrator 110 can produce improved prediction as to a baseline execution time (subject to adjustment in reference to a future timeslot with use of methods described in reference to utilization predictive model 4202 and/or execution time predictive model 4203) with use of the memoization and hashing function technique as referenced in connection with Table B herein.

For increasing the resolution of predictions obtained with use of instances of utilization predictive model 4202, orchestrator 110 can employ a feedback feature as set forth in the reference to utilization predictive model 4202 of FIG. 4A. As set forth in reference to FIG. 4A, orchestrator 110 can re-query utilization predictive model 4202 using the predictive next time period utilization parameter values, combined with predicted next time period weather parameter values collected from weather service system 180 for the geographical region of the relevant computer environment, and advancing the day classifier to the day classifier association to time period N+1. On being re-queried, utilization predictive model 4202 can produce weather forecast informed predictions for utilization parameter values at the subsequent time period, N+2.

For scaling scoring values under factor F2 (reliability), orchestrator 110 can query reliability predictive model 4302. Reliability predictive model 4302 can be trained in the manner of predictive model 4202 wherein the described utilization parameter values for training and querying can be replaced with reliability parameter values. Reliability predictive model 4302 can have a feedback feature for producing weather forecast informed predictions as described in connection with utilization predictive model 4202.

For scaling scoring values under factor F4 (energy consumption profile factor), orchestrator 110 can query energy supply profile predictive model 4402. Energy supply profile predictive model 4402 can be trained to return predictions as to an energy supply profile of a particular computer environment at a subsequent time period. Energy supply profile predictive model 4402 can be trained with iterations of training data and once trained is able to return predictions. Energy supply profile predictive model 4402 can be trained with the training data set on completion of each data collection period in which orchestrator 110 collects energy supply profile metrics data from a certain computer environment. An iteration of training data can include a day classifier specifying the date type associated to the data collection, e.g., weekday, weekend, holiday, the energy supply profile at time T, the time of data collection, the energy supply profile of the computer environment at time T−1, the energy supply profile of the computer environment at time T−2 (the training energy supply profiles can be expanded to time T minus N), and a set of weather parameter values specifying weather conditions at the time of the data collection. The described training data set can be iteratively applied for advancing subsequent data collection times T. Energy supply profile predictive model 4402, once trained, is able to return predictions as to energy supply profile of a computer environment of the subsequent time period time N+1.

Energy supply profile predictive model 4402 can be queried with the use of query data which can comprise a current day classifier, the day classifier for the day of the query, the current energy supply profile of the computer environment at the current time, time N, the energy supply profile of the computer environment at time N−1, the energy supply profile of the computer environment at time N−2 and the set of weather parameter values specifying weather conditions at the time of the query.

For adjusting predictions returned with use of energy supply profile predictive model 4402 and scoring values assigned under factor F4, orchestrator 110 can subject text based content from news aggregator system 160 to natural language processing by NLP process 115 for extraction of topics referencing sponsored programs for energy production as set forth herein.

On completion of evaluating at block 1107, orchestrator 110 can proceed to scheduling block 1108. At scheduling block 1108, orchestrator 110 can select the candidate schedule amongst the candidate schedules scored in a manner described in reference to Table A based on the candidate schedule producing the highest score on application of Eq. 1.

By leveraging the data structure provided by a workflow graph to organize relationships, the techniques described herein can reduce computational resources that are expended in intelligently deploying applications. In one example, for assigning scoring values under factor F1-F4, orchestrator 110 can write and read interim result data to and from nodes and/or edges of a workflow graph. For predicting a timeslot for a later stage job of an application, orchestrator 110 can write predicted execution times associated to preceding jobs to nodes (for hosting execution time of a job) and edges (for data delivery times of a job), and can read a sequence of written values for return of a predicted timeslot of the late job. Predictions as to aggregate reliability, cost, and/or renewable/non-renewable energy consumption can be returned with use of the same writing and reading method. Writing and reading from the referenced workflow graph data structure reduces computing resource consumption by avoiding a need to re-derive the relationships represented in the relationship graph on an iterative basis. With the described use of the workflow graph data structure, orchestrator 110 with reduced utilization of computing resources can easily handle advanced workflows in which branching to next nodes proceeds according to alternate routes in dependence on data determinations. In such a situation, orchestrator 110 can perform iterative calculations involving reading of values that have been to workflow graph data structure in dependence on a determination as to most likely workflow paths, determined with use of test data in one example.

At scheduling block 1108, orchestrator 110 can send scheduling data for receipt by computer environments of computer environments 150A to 150Z selected for hosting at least one job that is specified in a workflow. The scheduling data can include such data as the anticipated scheduled initiation time for a given job as well as predicted (forecasted) conditions of the scheduled job in terms, e.g., of utilization parameter values and/or energy supply profile parameter values. The scheduling data can also include data specifying attributes of an installation package to be sent to respective ones of the computer environments selected for deployment and/or prospective deployment. In one embodiment, an installation package can include the combination of a production image and a resource extraction test (RET) image.

The predicted conditions can include predicted energy supply profile conditions which can be based on predictions performed by orchestrator 110 using energy supply profile predictive model 4402 and/or a prediction, e.g., of an energy supplying profile with an increased percentage of energy supplied by renewable energy source generation attributable to findings derived by text-based processing of news aggregator information regarding incentive programs for renewable energy sources. On completion of scheduling block 1108, orchestrator 110 can proceed to deploying block 1109.

At deploying block 1109, orchestrator 110 can send for deployment, e.g., software images defining an installation package for instantiation of one or more job set forth in an application workflow diagram. On receipt of the installation packages, computer environments 150A to 150Z can at deploy block 1502 (where the scheduling references responsive instantiation) instantiate images of the installation packages deployed at block 1109 and can proceed to send block 1504 (if the job involves messaging users) to send messaging data to clients 170A to 170A associated users and the hosting computer environment can subsequently receive messaging data sent at block 1701 (in the case that a job involves servicing and users). In some use cases, where a job is scheduled to run at a later time after a delay from a current time, deployment can include e.g., deploying for storing virtual machine images (e.g., hypervisor based or container based) in storage, e.g., defined by data repository 208 (FIG. 1B), and instantiating the image for commencement of a runtime instance at a later time according to a scheduling at block 1108 which scheduling can be iteratively updated at iterations of block 1108.

In some use cases, an installation package can include a combination of production image and a resource extraction test (RET) image. The RET image (where running of a production image is to be delayed) can instantiate and run on receipt without a delay, and the production image can instantiate and run after a delay. A computer environment scheduled for hosting at least one job of a multi-job application at deploy block 1502, responsively to receiving an installation package sent at block 1109, can one or more of responsively instantiate an image without delay, or store an image for later instantiation after a delay.

At send block 1503, computer environments 150A to 150Z can send job data for processing by orchestrator 110. The job data can include metrics data describing performance of a job as well as status data, e.g., indicating whether a job is waiting instantiation, in progress or has completed. The job data can include output data from running of RET image as set forth herein.

On completion of block 1109, orchestrator 110 can proceed to query block 1110. At query block 1110, orchestrator 110 can proceed to query news aggregator system 160, e.g., for return of report data as set forth herein, which can be returned at send block 1601, specifying authority sponsored energy generation incentive programs, which can be subject to processing and detection by natural language processing.

On completion of query block 1110, orchestrator 110 can proceed to query block 1111. At query block 1111, orchestrator 110 can proceed to query weather service system 180, e.g., for return of weather parameter values, including predicted weather parameter values, which can be returned at send block 1801. Weather service system 180 can be configured to provide weather data defining the returned weather parameter values with respect to a region being serviced by system 100. Weather data can include, e.g., historical temperature data, precipitation data, wind data and weather event data. Weather data can include, e.g., current temperature data, precipitation data, wind data and weather event data. Weather data can include, e.g., forecast temperature data, precipitation data, wind data and weather event data. Weather events can include, e.g., storms including hurricanes, tornados, fog formations, heat waves and cold waves. Weather service system 170 can store weather data associated to different regions (subareas) of an area being serviced by system 100.

On completion of block 1111, orchestrator 110 can proceed to send block 1112. At send block 1112, orchestrator 110 can send visualization data as to a current status and/or metrics regarding the deployed application to a UE device of UE devices 130A-130Z. The receiving UE device at block 1303 can output the visualization data, e.g., to a display of a developer user. On completion of block 1112 orchestrator 110 can proceed to criterion block 1113.

At criterion block 1113, orchestrator 110 can ascertain whether one or more criterion has been satisfied in the hosting of the current hosted application. Such criterion can be whether targeted energy supply profiles have been satisfied, whether there has been a change in a current or predicted computer environment energy supply profile, whether a job scheduled to have been completed has actually completed, whether targeted performance metrics have been satisfied, and the like. On the determination by orchestrator 110 at criterion block 1113 that one or more criterion has not been satisfied, orchestrator 110 can return to a stage prior to block 1107 and can re-perform evaluating of candidate schedules as described in reference to Table A and Eq. 1.

On re-performing evaluating at block 1107 after an initial deployment of an application, orchestrator 110 can apply a modified version of Eq. 1 which includes an additional factor and associated weight, F5W5, which biases the selection in favor of re-selecting the current deployment as the selected candidate deployment. For example, orchestrator 110 can assign a scoring value of 1.0 (highest) according to factor F5 for the current deployment which would require rehosting of no jobs instantiated or not instantiated, can assign a scoring value of 0.9 under factor F5 if the candidate deployment would require job rehosting only as to jobs that have not yet instantiated, can assign a scoring value of 0.7 under factor F5 if the candidate deployment would require job rehosting only as to a single job currently instantiated and running, can assign a scoring value of 0.7 under factor F5 if the candidate deployment would require job rehosting only as to two jobs currently instantiated and running, and can assign a scoring value of 0.3 under factor F5 if the candidate deployment would require job rehosting as to three or more jobs currently instantiated and running.

Thus, referring to the loop of blocks 1107 to 1113, it can be seen that orchestrator 110 can alter the scheduling of a current application for hosting in dependence on examination of current data, e.g., data received pursuant to sending at send blocks 1503, 1602 or 1802 as set forth herein. In one example, the rescheduling can result in live migration of a job, instantiated with a virtual machine on a certain computer environment, to a different computer environment. In one example, the application rescheduling can result in rescheduling of a job scheduled for instantiation on a certain computer environment to a different computer environment.

According to one scenario, after deployment of an application in which one or more job is running, a change in predicted energy supply profile of a certain computer environment at a particular future timeslot (e.g., perhaps due to a weather forecast) can drive failure of a criterion block 1113 and selection (due to operation of factor F4) of a new candidate deployment at block 1107 in which a certain job is re-hosted to or from the certain computer environment. In another scenario, after deployment of an application in which one or more job is running, a change in offered resources (e.g., to more power hungry or less power hungry resources) of a certain computer environment can drive failure of a criterion block 1113 and selection (e.g., due to operation of factor F4) of a new candidate deployment at block 1107 in which a certain job is re-hosted to or from the certain computer environment. In one example, the criterion at block 1103 can include ascertaining whether the current deployment remains re-selected with application of the described modified version of Eq. 1 with factor F5 and associated weight W5. In such example, the modified version of Eq. 1 does not have to be re-applied at a next iteration of block 1107 if it was just applied at block 1113. In another example, on return of a no decision at decision block 1115, orchestrator 110 can return to evaluating block 1107 at which orchestrator 110 can apply the described modified version of Eq. 1 with factor F5 and associated weight W5.

In various scenarios, it can be seen that orchestrator 110 can dynamically adapt for reduction of non-renewable energy consumption to rehost one or more job defining a running application to a new computer environment in response to a changing condition, where the changing condition can be, e.g., a change in a predicted energy supply profile of at least one computer environment. Orchestrator 110 for performance of dynamic re-hosting can employ a variety of features for accurate realization of reduction of non-renewable energy consumption. In one aspect, instantiated RET images herein can be processed for precision identification of resource offerings. With resource offerings precisely identified, precise predictions on power consumption can be performed, as well as predictions (e.g., using memoization and hashing techniques herein) as to execution times of jobs to be performed on the resources referenced in the resource offerings. With use of workflow graphs, accurate timing relationships between jobs can be performed, including timing relationships encompassing data transmission times between jobs, which can be represented as edges between nodes of a workflow graph.

On the determination that the one or more criterion is satisfied at block 1113, orchestrator 110 can proceed to block 1115 without performing rescheduling of a current deployment schedule.

At block 1115, orchestrator 110 can ascertain whether a current application has completed processing. If orchestrator 110 determines at block 1115 that processing has not been completed, orchestrator 110 can return to the stage prior to block 1109 to reference the most recently determined scheduling as determined at block 1108 and to deploy at an iteration of block 1109, e.g., software images for an instantiation of a next function to perform according to an application workflow (if such function has not previously been deployed at a prior iteration of deploying block 1109). Orchestrator 110 can iteratively perform the loop of blocks 1109 to 1115 for a time that an application is running (or the loop of blocks 1107 to 1115 if repeat evaluation at block 1107 has been triggered).

On determination by orchestrator 110 at block 1115 that an application workflow has completed, orchestrator 110 can proceed to S/T block 1117. At S/T block 1117 orchestrator 110 can store data including metrics data received responsively to send blocks 1505, 1602, and 1802 and can perform training of predictive models 4202, 4203, 4302, 4402, 4502 using the received data. On completion of block 1115, orchestrator 110 can proceed to return block 1118. At return block 1118, orchestrator 110 can return to a stage preceding block 1106 to wait for selection data for defining characteristics of a next workflow graph and orchestrator 110 can perform a next iteration of the loop of blocks 1106 to 1118. Orchestrator 110 can be performing the loop of blocks 1106 for a plurality of application workflows represented by workflow graphs simultaneously and concurrently. UE devices 130A to 130Z can be iteratively performing the loop of blocks 1301 to 1304 for a deployment period of system 100. Enterprise systems 140A to 140Z can be iteratively performing the loop of blocks 1401 to 1404 for a deployment period of system 100. Computer environments 150A to 150Z can be iteratively performing the loop of blocks 1501 to 1506 for a deployment period of system 100. Clients 170A to 170Z can be iteratively performing the loop of blocks 1701 to 1702 for a deployment period of system 100. News aggregator system 160 can be iteratively performing the loop of blocks 1601 to 1603 for a deployment period of system 100. Weather service system 180 can be iteratively performing the loop of blocks 1801 to 1803 for a deployment period of system 100.

During the running of an application workflow mapped to a workflow graph, orchestrator 110 can be storing returned data including metrics data received responsively received responsively to send blocks 1505, 1602, and 1802, and applying the stored data including metrics data for training predictive models at S/T block 1114 and/or S/T block 1116. Trained predictive models can include predictive models 4202, 4203, 4302, 4402, 4502 as set forth hereinabove. In another example, trained predictive models at S/T training blocks herein can include one or more hashing function predictive models.

FIG. 4E illustrates a hashing function predictive model 4502. Training data for training hashing function predictive model 4502 can include input layers and results layer(s). Hashing function predictive model 4502, once trained, is able to respond to query data. Query data can be a known set of input layers. Hashing function predictive model 4502 on application of training data can produce a hash of input layers. On application of query data, hashing function predictive model 4502 can produce a hash of the input layers defining the query data and can match the hash of the input layers, to previously stored hashes. Orchestrator 110, responsively to the hashing of the input layers, can identify one or more previously stored hash stored in models area 2123 having a threshold satisfying (e.g., by Euclidian distance) to the hash of the query input layers. The described processing sets forth a memoization function that avoids an expensive function call, and returns results with reduced processing delay.

Table B below illustrates an example of embeddings that can be stored at S/T blocks 1114 and/or 1116.

TABLE B

| | |
|---|---|
| 1. | Resource requirements of the job (e.g., CPUs, memory, GPUs, number of nodes, etc.) |
| 2. | Information about the job logic (e.g., executable command line, container image, etc.) |
| 3. | Inputs and other data dependencies (e.g., inputs such as data that other steps computed, or data |
| | computed outside the bounds of the workflow, etc.). This also includes outputs of this job that |
| | other jobs in the same workflow graph will consume in the future. For example, if consumer |
| | tasks get scheduled on a different datacenter we will have to transfer this data out of this |
| | datacenter and into the datacenter(s) that handle the execution of the consumer tasks. Data |
| | transfers take time, and consume energy. Here there can also be included information about the |
| | producers of the input data to this job. |
| 4. | Hosting compute node information (e.g., CPU type, GPU model, etc.), e.g., as offered by the |
| | hosting computer environment. |
| 5. | Profiling information (execution time of job, job infrastructure utilization (e.g., hardware |
| | resources utilization, etc.). This is known after executing the job. |

In the example of Table B, layers 1 through 4 define known input layers that are subject to hashing to produce a database of prior stored hashes, e.g., on completion of each job. The fifth layer is a results layer associated to the stored hash. When a new set of input layers is applied as queried data, results associated to hash that matched (e.g., by threshold Euclidian distance) the results data associated to the matching historical hash can be used as a predictor of results associated to the query data defining input layers.

Orchestrator 110 can use the memoization function in a variety of useful ways. In one example, orchestrator 110 in performing evaluations with use of Eq. 1 can use an extracted predicted execution time extracted using the memoization function to Table B as the determined runtime of a job for purposes of assigning scoring values under factor F1 of Eq. 1. In another example, orchestrator 110 can use an extracted execution time extracted using the memoization function to Table B as a baseline determined execution time, to be scaled using the technique set forth in reference to execution time predictive model 4203 described in reference to FIG. 4B. In another example, orchestrator 110 can use an extracted execution time extracted using the memoization function to Table B in order to scale returned hosting computer environment utilization parameter values returned using utilization predictive model 4202 set forth in reference to FIG. 4A.

In another example, orchestrator 110 can use the extracted predicted execution time extracted and extracted job infrastructure utilization parameter values using the memoization function to Table B in order to determine energy consumption of a job for purposes of scaling factor F4 scoring values of Eq. 1. Prior to an application being deployed in a production environment, orchestrator 110 can use results from a test environment obtained at generating block 1106 for purposes of predicting power consumption of a job as a function of execution time and job infrastructure utilization. However, after production environment results are available, orchestrator 110 can employ hashing function predictive model 4502 and the memoization technique of Table B for purposes of scaling scoring values under factor F4 of Eq. 4.

At deploying block 1109, orchestrator 110 can send an installation package including job performing software images (e.g., container images) to their selected computer environment on an anticipatory basis, e.g., prior to a time scheduled for instantiation of the images for runtime performance of a job. In another aspect, orchestrator 110 with the sending of job performing production software images at block 1109 can send associated resource extraction test (RET) images (e.g., provided by container images), wherein there is a RET image associated to respective ones of the job performing production images. In one aspect, an RET image can be provisioning to include emulating code for emulating, in runtime, aspects of functioning of a job.

In one aspect, orchestrator 110 can package together with a production image for performance of a job, an RET image, which when instantiated for running behaves like a runtime instantiated production image from a resource requirement perspective, but quickly runs to completion. Embodiments herein can use these RET images to perform quick tests to guide the infrastructure defined by a computer environment to select the proper resource set for allocation with improved specificity relative to what can be returned in response to generalized (e.g., SLA) requirements. The RET images can be agnostic of the infrastructure. In one embodiment, a developer user authoring a production image can author a RET image based on the developer user's understanding of the operation of the RET image. An installation package including a production image and a RET image can include metadata readable by a receiving computer environment that specifies that a RET image has been included in a package. On the reading of the described metadata, the receiving computer environment can instantiate and run the RET image without delay independent of a current scheduling for instantiation and running of its associated production. For running of the RET image, the receiving computer environment can select an arbitrarily large resource capable of instantiating and running of the typically lightweight RET image.

The RET image, in one embodiment, can be configured to include content in common with its associated production image. For example, the RET image can have code in common with its associated production image but just running a small number of iterations where the production image uses a repetitive pattern and that small number of iterations is representative of the overall performance. The RET image execution can be configured to be compatible with the same commands, environment, and storage used for the production image. The RET image execution can be configured so as not to create or delete data, and consequently, can be configured so as not to corrupt data.

Receiving computer environments can be configured so that if a receiving computer environment detects a RET image in a manifest received package, e.g., by means of metadata, the hosting computer environment can load and execute the lightweight RET image on an arbitrarily large resource set for performance of test runs. Based on dynamic analysis runtime performance testing of the test runs, the computer environment can identify a production resource set for hosting instantiation of the production image. The running instance (e.g., container) of the RET image can report back to orchestrator 110 at iterations of block 1505 the current reported and offered resource set offered for instantiation and hosting. The offered resource set can define the layer 4 data specified in Table B. The computer environment can iteratively send (and possibly update) the offered resource set until the scheduled time of instantiation for the production image. At the scheduled time for running of the production image for performance of a job, the hosting computer environment can load the selected resource set with the production image, execute the workload, drop resources used during the search for resources and make those available for other purposes. Orchestrator 110 can use the offered resource set for generating predictions on execution times for jobs, as explained in connection with Table B, and for purposes of predicting energy consumption when performing evaluations under factor F4.

In another aspect of instantiations of RET images herein, orchestrator 110 can package within a RET image executable code that causes the receiving computer environment to message a power grid authority. Orchestrator 110 can embed in such executable code a specified renewable energy delivery, e.g., specified in dependence on a predicted energy deliver produced based on attributes of an authority sponsored incentive program detected using natural language processing as set forth herein. The described executable code can be configured so that on execution of the executable code, the receiving and hosting computer environment can message at block 1503 a power grid authority enterprise the requested specified renewable energy delivery. The power grid authority enterprise at block 1402 can process the request, and can send return message data to the computer environment at send block 1403. The computer environment can report back with metrics data sending at a next iteration of block 1701 as to whether the specified renewable energy delivery was satisfied. Orchestrator 110 can perform re-evaluating and/or rescheduling at blocks 1113, 1107, 1108 if the specified renewable energy request was not satisfied. Accordingly, there is set forth herein, in one aspect, predicting future energy supply profiles at respective ones of a plurality of geographically differentiated computer environments, wherein the respective energy supply profiles at the respective ones of a plurality of geographically differentiated computer environments express an attribute of supplied energy supplied to a computer environment attributable to renewable power generation; scheduling a plurality of jobs defining an application workflow, wherein the application workflow is characterized by commencement of a second job of the plurality of jobs being dependent on completion of a first job of the plurality of jobs, wherein the scheduling is performed in dependence on the predicting future energy supply profiles at the respective ones of a plurality of geographically differentiated computer environments and in dependence on a forecasting of an execution time of the first job and the second job; and deploying at least one job of the plurality of jobs defining the application workflow according to the scheduling, wherein the method includes dynamically rescheduling hosting of one or more job of the plurality of jobs during the running of the application so that a hosting computer environment of the one or more job is changed, wherein the dynamically rescheduling is performed in dependence on a predicted change in an energy supply profile of at least one computer environment, the predicted change resulting from detecting of an energy generation incentive program, wherein the detecting has included subjecting text based report data to natural language processing, wherein the report data is report data of an authority associated to a geographic region in common with a geographic region of the at least one computer environment, wherein the method includes generating request data in dependence on the detecting, the request data referencing delivery of a specified renewable energy supply, wherein the method includes sending the request data to the at least one computer environment to trigger messaging between the at least one computer environment and a power grid authority.

Embodiments herein recognize that at iterations of scheduling block 1108 after an initial scheduling, orchestrator 110 can perform scheduling so that the scheduling at block 1108 defines a dynamic revising of a prior scheduling. The dynamic revising can comprise, e.g., scheduling rehosting of one or more job to a new computer environment and/or can comprise revising of predicted timings between jobs and predicted timeslots for jobs. The revised timing information can be sent to the relevant computer environments at scheduling block 1108. In one example, improved and more accurate timing information can be determined as additional metrics data is sent to orchestrator 110 at iterations of block 1505. In one example, predicted timeslots for performance of jobs can be provided with improved precision based on, e.g., additional specific resources being offered by computer processing on processing of instantiations of RET images herein, and/or as the corpus of historical execution times used for performance of the hashing and memoization method herein grows. Accordingly, there is set forth herein, in one aspect, predicting future energy supply profiles at respective ones of a plurality of geographically differentiated computer environments, wherein the respective energy supply profiles at the respective ones of a plurality of geographically differentiated computer environments express an attribute of supplied energy supplied to a computer environment attributable to renewable power generation; scheduling a plurality of jobs defining an application workflow, wherein the application workflow is characterized by commencement of a second job of the plurality of jobs being dependent on completion of a first job of the plurality of jobs, wherein the scheduling is performed in dependence on the predicting future energy supply profiles at the respective ones of a plurality of geographically differentiated computer environments and in dependence on a forecasting of an execution time of the first job and the second job; and deploying at least one job of the plurality of jobs defining the application workflow according to the scheduling, wherein the method includes dynamically rescheduling hosting of one or more job of the plurality of jobs during the running of the application so that a hosting computer environment of the one or more job is changed, wherein the dynamically rescheduling is performed in dependence on one or more of the following selected from the group consisting of (a) a predicted change in an energy supply profile of the computer environment, (b) an attribute of predicted weather at a region of a computer environment, as specified in a weather forecast of the region, (c) an energy generation incentive program, identified by subjecting text based report data to natural language processing, and (d) a change in an offered computer environment resource for hosting the one or more job, wherein the dynamically rescheduling initiates live migration of the one or more job to another one or more hosting computer environment. Accordingly, there is set forth herein, in one aspect, predicting future energy supply profiles at respective ones of a plurality of geographically differentiated computer environments, wherein the respective energy supply profiles at the respective ones of a plurality of geographically differentiated computer environments express an attribute of supplied energy supplied to a computer environment attributable to renewable power generation; scheduling a plurality of jobs defining an application workflow, wherein the application workflow is characterized by commencement of a second job of the plurality of jobs being dependent on completion of a first job of the plurality of jobs, wherein the scheduling is performed in dependence on the predicting future energy supply profiles at the respective ones of a plurality of geographically differentiated computer environments and in dependence on a forecasting of an execution time of the first job and the second job; and deploying at least one job of the plurality of jobs defining the application workflow according to the scheduling, wherein the scheduling includes scheduling the first job for running on a first of the plurality of computer environments in dependence on a predicted energy supply profile at the first computer environment at a predicted time of performance of the first job, and scheduling the second job for running on a second of the plurality of computer environments in dependence on a predicted energy supply profile at the second computer environment at a predicted time of performance of the second job, wherein the predicted time of performance of the second job is dependent on or more of the following selected from the group consisting of (a) a predicted data transfer time between the first job and the second job as determined based on a geographical distance separation between a hosting computer environment of the first job and the second job, (b) an offered resource for hosting the second job as determined by processing an instantiation of a resource extraction image that emulates an attribute of performance of the second job, and (c) a baseline predicted execution run time returned with use a hashing method in which a hash of predicted inputs is matched to a hash of historical inputs for access of result data associated to the hash of historical inputs.

Embodiments herein recognize that as renewable energy generation expands, authorities associated to regions are finding that grid infrastructure is not well suited to less predictable generating capacity of renewable energy. Embodiments herein recognize that one factor is that excess energy storage and geographical energy exchange require expensive new or modified infrastructure. Embodiments herein recognize that the described challenges can lead to either wasted generation, payments to infrastructure maintainers to not produce energy at certain periods, or continued reliance on non-renewable energy. Embodiments herein recognize that at the same time, global cloud computing resources are expanding which often utilize large amounts of energy and serve many organizations and individuals computational resources.

Embodiments herein can employ workflow operators and data reuse systems to bring novel capabilities to green cloud computing. Embodiments herein can workload orchestrators, such as computational workflow orchestrators, to estimate a job's completion time, data transfer time, energy consumption, and carbon footprint. Embodiments herein can employ use of the workflow graph, a definition of an application's computation's steps and interconnected components. A workflow graph can be, e.g., a directed graph or an undirected graph.

Embodiments herein recognize that consuming energy increases the carbon footprint of computational workflows by a factor that is dependent on an energy supply profile of a computer environment.

Embodiments herein can employ, for example, (1) a workflow definition of an which can be known a priori to deployment of an application on one or more computer environment; (2) a mechanism to predict the execution time, data transfer time, energy consumption, monetary cost, and carbon footprint of energy consumption for computational workloads defined by jobs running in one or more computer environment; (3) a monitoring system of one or more execution environment (e.g., for energy consumption, carbon footprint, workload, etc.), and/or (4) a monitoring systems for service-level agreements.

Embodiments herein can employ features herein to dynamically provision computational workloads to one or more, potentially geographically distributed computer environments defined by data centers. The described provisioning enables forward estimation of energy usage through pre-scheduling, allowing computer environments to inform local grid operators, and other entities, who may otherwise not make renewable energy available. Embodiments herein can include a method that uses a workflow graph to forecast and pre-schedule computational workloads defined by jobs across computer environments (e.g., data centers) depending on their predicted performance and energy consumption behavior. The use of the workflow graph can facilitate accounting of data transfers when scheduling in geographically diverse locations. Embodiments set forth herein enable entities external to a hosting computer environment (e.g., energy providers) to use the forecasts to make informed decisions about power generation. Energy grid providers, for example, can use forecasts in order to provide green energy to datacenters running computational workloads defined by jobs.

In one aspect, an orchestrator 110 ingests a workflow graph and can estimate compute time of each job defining an application workflow. In one aspect, a workflow graph can be used to estimate when each job of the workflow will be ready to run. In another aspect orchestrator 110 can access information on the renewable energy available at computer environments, e.g., provided by geographically diverse data centers.

In one example, orchestrator 110 can discover that currently renewable energy generation is being artificially suppressed to avoid energy overloads in a certain geographical region associated to a certain authority. In the described example, orchestrator 110 can predict that routing workloads defined by jobs to computer environments in the geographical region will reduce operational costs by 50% (e.g., because the authority associated to the geographical region will pay the computer environment operator to use the surplus energy so that it does not have to pay the energy company to shut down its wind turbines) and execution-time by 25% (e.g., because said data centers feature powerful GPU accelerators that draw a lot of power). In turn, the workload orchestrator 110 can schedule most of the computation to a computer environment of the certain geographical region.

Further to the referenced example, orchestrator 110 can predict that final jobs defining a workflow will run ten hours later plus or minus half an hour. Orchestrator 110 in the referenced example can ascertain that a computer environment in the certain geographical region will only have a limited amount of renewable energy available through battery storage, and can ascertain that the geographical region having the most renewable energy at the relevant time is in a second geographical region. Considering the effects of data transfer, orchestrator 110 can select the second geographical region and the last jobs can be pre-scheduled for deployment in a computer environment of the second geographical region. Orchestrator 110 can continue to monitor energy generation throughout geographically diverse computer environments and will reallocate jobs to different geographic computer environments on detections of changed conditions. Embodiments herein facilitate smart allocation of jobs, maximizing renewable energy usage to both reduce the operational cost of data computer environments and to help authorities associated to geographical regions maintain healthy energy grids.

Embodiments herein can include deploying jobs to the most suitable computer environment based upon a computational workflow and renewable energy generation capacity. Embodiments herein can include (1) energy usage forecasting, e.g., provided based on a suitable embedding; (2) scheduling of workflow deployments, wherein jobs can be scheduled over a network of computer environments based upon the likelihood of available renewable energy.

Embodiments herein can pre-schedule computational workflows because orchestrator 110 can forecast the behavior of such before they are even created. Embodiments herein can migrate a workload defined by a job to a more suitable computer environment after the workload has started executing. Embodiments herein can include segmenting workflow graphs into arbitrary units of at least one computational task and pre-schedule these at a suitable computer environment.

Workflow graphs herein can encode data transfer processes with estimated data size, execution time, energy consumption, and associated carbon footprint. Orchestrator 110 can use such workflow graph encoded data when returning execution time, energy consumption, and carbon footprint when selecting the geographic location (computer environment at particular location) to run various jobs.

Application-level embedding methods with compute run time can estimate time to completion and an uncertainty estimate based upon job requirements. The following provides example embodiments of our disclosure to assist in explaining the usage of the concepts in this disclosure. There are many forms of renewable energy such as solar, wind, tidal and nuclear. Embodiments herein, in one aspect, can consider the renewable energy sources which have an environmental dependence (for example solar, wind and tidal) which are some of the most cost effective and widespread renewable energy generation technologies to date. All of these generation methods have a dependence on the environment for their operation (is it sunny, is it windy, tide times). As an example, we will focus on solar power, but equivalent descriptions and arguments can be made for the other generation methods.

Various available tools, libraries, and/or services can be utilized for implementation of predictive models herein. For example, a machine learning service can provide access to libraries and executable code for support of machine learning functions. A machine learning service can provide access set of REST APIs that can be called from any programming language and that permit the integration of predictive analytics into any application. Enabled RE APIs can provide, e.g., retrieval of metadata for a given predictive model, deployment of models and management of deployed models, online deployment, scoring, batch deployment, stream deployment, monitoring and retraining deployed models. A machine learning service can provide access set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. Predictive models herein can employ use of, e.g., neural networks, support vector machines (SVM), Bayesian networks, and/or other machine learning technologies.

Certain embodiments herein may offer various technical computing advantages involving computing advantages to address problems arising in the realm of computer systems and computer networks. Embodiments herein can feature improved scheduling and deploying an application workflow by methods in which jobs occurring at different times, can be hosted at different hosting computer environment according to hosting environment selections performed in dependence on predicted conditions at the various hosting computer environments. Embodiments can feature use of a workflow graph onto which data can be written to and read from for economized evaluations of candidate deployments, thus facilitating time critical deployments. Embodiments herein can also feature memoization techniques for use in obtaining predicted outputs on a resource conserving basis, as well as use of resource extraction test (RET) images for computing resource conserving identification of optimized hosting resources within a computer environments. Embodiments herein can feature use of trained predictive models for use in returning predictions on execution times, energy consumption profiles, and other performance metrics. In various scenarios, an orchestrator can dynamically adapt for reduction on non-renewable energy consumption to rehost one or more job defining a running application to a new computer environment in response to a changing condition, where the changing condition can be, e.g., a change in a predicted energy supply profile of at least one computer environment. An orchestrator for performance of dynamic re-hosting can employ a variety of features for realization of accurate reduction on non-renewable energy consumption. In one aspect, instantiated RET images herein can be processed for identification of precision resource offering. With resource offerings precisely identified, precise predictions on power consumption can be performed, as well as predictions (e.g. using memoization and hashing techniques herein) as to execution times of jobs to be performed on the resource offerings. With use of workflow graphs, accurate timing relationships between jobs can be performed, including timing relationships encompassing data transmission times between jobs, which can be represented as edges between nodes of a workflow graph. Embodiments herein feature advances in technology for organized and intelligent reductions on non-renewable energy consumption. Embodiments herein can also feature use of natural language processing for identification of authority sponsored incentives involving energy generation and responsive messaging functionality. Embodiments herein can include artificial intelligence processing platforms featuring improved processes to transform unstructured data into structured form permitting computer based analytics and decision making. Embodiments herein can include particular arrangements for both collecting rich data into a data repository and additional particular arrangements for updating such data and for use of that data to drive artificial intelligence decision making. Certain embodiments may be implemented by use of a cloud platform/data center in various types including a Software-as-a-Service (SaaS), Platform-as-a-Service (PaaS), Database-as-a-Service (DBaaS), and combinations thereof based on types of subscription.

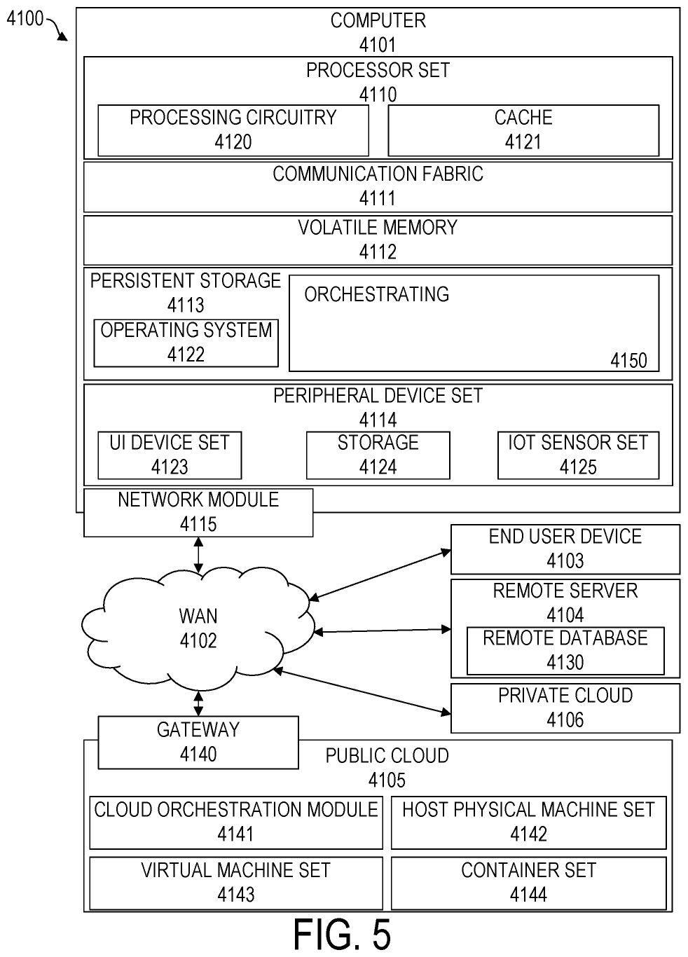

In reference to FIG. 5 there is set forth a description of a computing environment 4100 that can include one or more computer 4101. In one example, computing node 10A-10Z as set forth herein can be provided in accordance with computer 4101 as set forth in FIG. 5.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 5. In one aspect, a computing environment 4100 contains an example of an environment for the execution of at least some of the computer code involved in performing the inventive methods, such as code 4150 for performance of orchestrating as set forth in reference to FIGS. 1A-4E. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IoT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 1A. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid state storage devices. Operating system 4122 may take several forms, such as various known proprietary operating systems or open source. Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101), and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention illustrated with reference to prophetic examples. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method comprising:
predicting future energy supply profiles at respective ones of a plurality of geographically differentiated computer environments, wherein the respective future energy supply profiles at the respective ones of the plurality of geographically differentiated computer environments express an attribute of supplied energy supplied to a computer environment attributable to renewable power generation;
scheduling a plurality of jobs defining an application workflow, wherein the application workflow is characterized by commencement of a second job of the plurality of jobs being dependent on completion of a first job of the plurality of jobs, wherein the scheduling is performed in dependence on the predicting the future energy supply profiles at the respective ones of the plurality of geographically differentiated computer environments and in dependence on a forecasting of an execution time of the first job and the second job; and
deploying at least one job of the plurality of jobs defining the application workflow according to the scheduling.

2. The computer implemented method of claim 1, wherein the scheduling includes scheduling the first job for running on a first computer environment of the plurality of geographically differentiated computer environments in dependence on a predicted energy supply profile at the first computer environment at a time of performance of the first job, and scheduling the second job for running on a second computer environment of the plurality of geographically differentiated computer environments in dependence on a predicted energy supply profile at the second computer environment at a time of performance of the second job.

3. The computer implemented method of claim 1, wherein the forecasting the execution time of the first job includes forecasting a time for sending message data of the first job to a location of a subsequent job, wherein according to the forecasting the execution time of the first job includes evaluating a candidate deployment in which the first job and the second job run on geographically differentiated computer environments.

4. The computer implemented method of claim 1, wherein the method includes generating a data structure provided by workflow graph that includes first and second nodes referencing, respectively, the first and second jobs, and a plurality of edges including an edge that connects the first and second nodes, wherein the scheduling includes evaluating first and second candidate deployments, and wherein the evaluating includes reading forecasted performance data that has been written to the first and second nodes, and to the edge of the data structure.

5. The computer implemented method of claim 1, wherein scheduling includes scheduling the first job on a first computer environment of the plurality of geographically differentiated computer environments in dependence on a predicted energy supply profile at the first computer environment at a time of performance of the first job, and scheduling the second job on a second computer environment of the plurality of geographically differentiated computer environments in dependence on a predicted energy supply profile at the second computer environment at a predicted time of performance of the second job, wherein the method includes dynamically rescheduling hosting of one or more job of the plurality of jobs during running of the application workflow so that a hosting computer environment of the one or more job is changed, wherein the dynamically rescheduling is performed in dependence on a predicted change in an energy supply profile of the computer environment.

6. The computer implemented method of claim 1, wherein the method includes dynamically rescheduling hosting of one or more job of the plurality of jobs during running of the application workflow so that a hosting computer environment of the one or more job is changed, wherein the dynamically rescheduling is performed in dependence on one or more of the following selected from the group consisting of (a) a predicted change in an energy supply profile of the computer environment, (b) an attribute of predicted weather at a region of a computer environment, as specified in a weather forecast of the region, (c) an energy generation incentive program, identified by subjecting text based report data to natural language processing, and (d) a change in an offered computer environment resource for hosting the one or more job.

7. The computer implemented method of claim 1, wherein the method includes dynamically rescheduling hosting of one or more job of the plurality of jobs during running of the application workflow so that a hosting computer environment of the one or more job is changed, wherein the dynamically rescheduling is performed in dependence on one or more of the following selected from the group consisting of (a) a predicted change in an energy supply profile of the computer environment, (b) an attribute of predicted weather at a region of a computer environment, as specified in a weather forecast of the region, (c) an energy generation incentive program, identified by subjecting text based report data to natural language processing, and (d) a change in an offered computer environment resource for hosting the one or more job, wherein the dynamically rescheduling initiates live migration of the one or more job to another one or more hosting computer environment.

8. The computer implemented method of claim 1, wherein the scheduling includes scheduling the first job for running on a first computer environment of the plurality of geographically differentiated computer environments in dependence on a predicted energy supply profile at the first computer environment at a predicted time of performance of the first job, and scheduling the second job for running on a second computer environment of the plurality of geographically differentiated computer environments in dependence on a predicted energy supply profile at the second computer environment at a predicted time of performance of the second job, wherein the predicted time of performance of the second job is dependent on or more of the following selected from the group consisting of (a) a predicted data transfer time between the first job and the second job as determined based on a geographical distance separation between a hosting computer environment of the first job and the second job, (b) an offered resource for hosting the second job as determined by processing an instantiation of a resource extraction image that emulates an attribute of performance of the second job, and (c) a baseline predicted execution run time returned with use a hashing method in which a hash of predicted inputs is matched to a hash of historical inputs for access of result data associated to the hash of historical inputs.

9. The computer implemented method of claim 1, wherein the scheduling is performed in dependence on a predicted data transfer time between the first job and the second job as determined based on a geographical distance separation between a hosting computer environment of the first job and the second job.

10. The computer implemented method of claim 1, wherein the scheduling is performed in dependence on an offered resource for hosting the second job as determined by processing an instantiation of a resource extraction image that emulates an attribute of performance of the second job.

11. The computer implemented method of claim 1, wherein the scheduling is performed in dependence on a baseline predicted execution run time returned with use a hashing method in which a hash of predicted inputs is matched to a hash of historical inputs for access of result data associated to the hash of historical inputs.

12. The computer implemented method of claim 1, wherein scheduling includes scheduling the first job on a first computer environment of the plurality of geographically differentiated computer environments in dependence on a predicted energy supply profile at the first computer environment at a time of performance of the first job, and scheduling the second job on a second computer environment of the plurality of geographically differentiated computer environments in dependence on a predicted energy supply profile at the second computer environment at a time of performance of the second job, wherein the scheduling is performed in dependence on an offered resource for hosting the second job as determined by processing an instantiation of a resource extraction image that emulates an attribute of performance of the second job, and wherein the scheduling is performed in dependence on a baseline predicted execution run time returned with use a hashing method in which a first hash of predicted inputs is matched to a second hash of historical inputs for access of result data associated to the second hash of historical inputs.

13. The computer implemented method of claim 1, wherein the method includes dynamically rescheduling hosting of one or more job of the plurality of jobs during running of the application so that a hosting computer environment of the one or more job is changed, wherein the dynamically rescheduling is performed in dependence on a predicted change in an energy supply profile of at least one computer environment, the predicted change resulting from detecting of an energy generation incentive program, wherein the detecting has included subjecting text based report data to natural language processing.

14. The computer implemented method of claim 1, wherein the predicting is performed in dependence on weather forecast data from a weather service system.

15. The computer implemented method of claim 1, wherein the respective energy supply profiles at the respective ones of the plurality of geographically differentiated computer environments express a percentage of supplied energy supplied to a computer environment attributable to renewable power generation.

16. The computer implemented method of claim 1, wherein the method includes dynamically rescheduling hosting of one or more job of the plurality of jobs during running of the application so that a hosting computer environment of the one or more job is changed, wherein the dynamically rescheduling is performed in dependence on a predicted change in an energy supply profile of at least one computer environment, the predicted change resulting from detecting of an energy generation incentive program, wherein the detecting has included subjecting text based report data to natural language processing, wherein the report data is report data of an authority associated to a geographic region in common with a geographic region of the at least one computer environment, wherein the method includes generating request data in dependence on the detecting, the request data referencing delivery of a specified renewable energy supply, wherein the method includes sending the request data to the at least one computer environment to trigger messaging between the at least one computer environment and a power grid authority.

17. A computer program product comprising:
a computer readable storage medium readable by one or more processing circuit and storing instructions for execution by one or more processor for performing a method comprising:
predicting future energy supply profiles at respective ones of a plurality of geographically differentiated computer environments, wherein the respective future energy supply profiles at the respective ones of the plurality of geographically differentiated computer environments express an attribute of supplied energy supplied to a computer environment attributable to renewable power generation;
scheduling a plurality of jobs defining an application workflow, wherein the application workflow is characterized by commencement of a second job of the plurality of jobs being dependent on completion of a first job of the plurality of jobs, wherein the scheduling is performed in dependence on the predicting the future energy supply profiles at the respective ones of the plurality of geographically differentiated computer environments and in dependence on a forecasting of an execution time of the first job and the second job; and
deploying at least one job of the plurality of jobs defining the application workflow according to the scheduling.

18. A system comprising:
a memory;
at least one processor in communication with the memory; and
program instructions executable by one or more processor via the memory to perform a method comprising:
predicting future energy supply profiles at respective ones of a plurality of geographically differentiated computer environments, wherein the respective future energy supply profiles at the respective ones of the plurality of geographically differentiated computer environments express an attribute of supplied energy supplied to a computer environment attributable to renewable power generation;
scheduling a plurality of jobs defining an application workflow, wherein the application workflow is characterized by commencement of a second job of the plurality of jobs being dependent on completion of a first job of the plurality of jobs, wherein the scheduling is performed in dependence on the predicting the future energy supply profiles at the respective ones of the plurality of geographically differentiated computer environments and in dependence on a forecasting of an execution time of the first job and the second job; and
deploying at least one job of the plurality of jobs defining the application workflow according to the scheduling.

19. The system of claim 18, wherein the method includes dynamically rescheduling hosting of one or more job of the plurality of jobs during running of the application workflow so that a hosting computer environment of the one or more job is changed, wherein the dynamically rescheduling is performed in dependence on each of (a) a predicted change in an energy supply profile of the computer environment, (b) an attribute of predicted weather at a region of a computer environment, as specified in a weather forecast of the region, (c) an energy generation incentive program, identified by subjecting text based report data to natural language processing, and (d) a change in an offered computer environment resource for hosting the one or more job, wherein the dynamically rescheduling initiates live migration of the one or more job to another one or more hosting computer environment.

20. The system of claim 18, wherein the scheduling includes scheduling the first job for running on a first computer environment of the plurality of computer environments in dependence on a predicted energy supply profile at the first computer environment at a predicted time of performance of the first job, and scheduling the second job for running on a second computer environment of the plurality of computer environments in dependence on a predicted energy supply profile at the second computer environment at a predicted time of performance of the second job, wherein the predicted time of performance of the second job is dependent on each of (a) a predicted data transfer time between the first job and the second job as determined based on a geographical distance separation between a hosting computer environment of the first job and the second job, (b) an offered resource for hosting the second job as determined by processing an instantiation of a resource extraction image that emulates an attribute of performance of the second job, and (c) a baseline predicted execution run time returned with use a hashing method in which a hash of predicted inputs is matched to a hash of historical inputs for access of result data associated to the hash of historical inputs.
